(19) United States
(12) Patent Application Publication
(10) Pub. No.: US 2023/0416143 A1
(43) Pub. Date: Dec. 28, 2023

(54) METHOD OF MANUFACTURING POROUS SINTERED PYREX®-TYPE GLASS AND METHODS OF SYNTHESIZING COMPOSITES AND POWDERS OF ALKALINE EARTH SILICATES

(71) Applicant: Jacob HORMADALY, Omer (IL)

(72) Inventor: Jacob HORMADALY, Omer (IL)

(21) Appl. No.: 18/251,810

(22) PCT Filed: Nov. 10, 2021
(86) PCT No.: PCT/IL2021/051338

§ 371 Date: May 4, 2023

Related U.S. Application Data
(60) Provisional application No. 63/112,249, filed on Nov. 11, 2020.

(51) Int. Cl. C03C 11/00; C03C 1/00; C03C 3/089; C03C 10/00; C03B 19/06; C03B 19/08

(52) U.S. Cl. CPC C03C 11/005; C03C 1/002; C03B 19/08; C03C 10/0054; C03B 19/063; C03C 3/089

(57) ABSTRACT

The invention provides a process for preparing a porous glass, comprising mixing borosilicate glass powder with calcium carbonate particles to form a mixture, sintering the mixture at a temperature in the range from 750 to 850° C. to obtain a sintered body, cooling the sintered body and leaching calcium carbonate from the cooled sintered body with the aid of an acid. The invention also provides a process for the preparation of one or more alkaline earth metal silicates by reacting a vitreous material and an alkaline earth carbonate, optionally in the presence of a transition metal or post-transition metal oxide, at a temperature lower than 1200° C., to form a composite consisting of one or more alkaline earth metal silicates and a residual glass, and optionally recovering the one or more silicates.

Porous glass, owing to its controllable pore size distribution, is an effective filtering material. Porous glasses are prepared by three main routes: liquid (water, acid, alcohol) leaching of phase separated alkali borosilicate, sol-gel processes and sintering of glass powders.

The invention relates to the latter method, i.e., the sintering of glass powders. The method in fact includes several variants which are quite different from one another.

A first variant involves mixing of glass particles of a specified size with a binder, compacting the mixture into the desired shape and heat treating the compact to sinter it so the sintered filter meets the requirements of strength, pore diameter and permeability. Different grades of filters having a broad range of pore sizes are made by the selection of glass particle size and heat treatment cycle. The pore size ranges from about one micron to about 300 microns and the porosity is limited to about 35% for pore sizes smaller than 65 microns.

The second variant of sintering glass powder is based on organic templates. The templates are filled with glass slurry, dried and heat processed to burn the organic template and then sinter the glass particles to yield very porous glass.

The third variant of sintering glass powder to a porous glass is based on the incorporation of pore forming material. A variety of pore forming materials such as carbon, silicon carbide (SiC) and aluminum nitride (AlN) were reported. Carbon reacts with air to give CO₂; silicon carbide reacts with air and transforms to SiO₂ and CO₂; whereas aluminum nitride reacts similarly to produce Al₂O₃ and N₂. SiO₂ and Al₂O₃ simply remain in the sintered porous glass. The extent and the type of porosity depend on the composition of glass powder, the type of pore forming material and process conditions. Glasses with low viscosity in the sintering range, form closed pores with the pore forming material during the sintering. The extent of closed pore formation can be utilized for foamed glasses.

The fourth variant of sintering glass powder to a porous glass is the recent capillary suspension processing reported e.g., by J. Maurath, J. Dittmann, N. Schultz, N. Willenbacher, Fabrication of highly porous glass filters using capillary suspension processing, Sep. Purif. Technol. 149 (2015) 470-478).

The invention relates to the third variant, more precisely, to an approach to selecting a pore forming material that was shown in U.S. Pat. No. 4,588,540, in which a leachable salt additive is mixed with a glass powder. A key requirement placed on the salt additive is that its melting point is higher than the sintering temperature of the glass and that the volume of the pore forming material (i.e., the leachable additive) does not change in the sintering process. The powder blend consisting of the glass constituents and the leachable salt additive is sintered, the sintered body is cooled and then, under the action of a leachate, the salt additive is dissolved and removed from the sintered body, to form a porous glass. A few classes of leachable salt additives were mentioned in U.S. Pat. No. 4,588,540, e.g., halides, sulfates, sulfides, carbonates, phosphates, chromates, tungstates, aluminates, silicates and zirconates, but only halides and sulfates were tested experimentally in U.S. Pat. No. 4,588,540, using water as a leachate.

We have now studied whether alkaline earth carbonates (calcium carbonate, strontium carbonate and barium carbonate) could act as pore forming additives in alkali borosilicate glasses, namely, in Pyrex®-type glass. CaCO₃ decomposes to calcium oxide (CaO) and CO₂ in the 600° C.-800° C. temperature range whereas SrCO₃ and BaCO₃ decompose at a higher temperature, >1000° C.

Experimental work conducted in support of this invention revealed a different reactivity of the three alkaline earth carbonates with Pyrex® glass. Only CaCO₃ emerged as a useful pore forming material in sintered Pyrex® glass. There exists a fairly narrow temperature range, e.g., from 750 to 825° C., in which an admixture of Pyrex® glass and calcium carbonate powders could be sintered without a reaction between the constituents taking place (i.e., the glass does not react with calcium carbonate or its decomposition product calcium oxide). Calcium carbonate or its decomposition product CaO could subsequently be leached out from the sintered glass with the aid of a mineral acid to give a product qualifying as a porous glass material.

Some key results of the experimental work reported herein are seen in the X-ray diffraction (XRD) patterns shown in FIG. 1, which correspond to samples of ball milled Pyrex®-type glass and 20 wt. % CaCO₃ before sintering (JH-052-117A), after sintering at 750° C. (JH-052-117B) and after leaching the sintered substrate in HCl solution (JH-052-117C). The shaping of the substrates was done with no pressure, i.e., the samples were not processed into pellets. The XRD pattern of the powder blend before sintering (JH-052-117A) shows the vitreous phase and diffraction lines assigned to CaCO₃. The XRD pattern of the sintered sample (JH-052-117B) shows the vitreous phase and diffraction lines assigned to CaCO₃ (major phase) and CaO (minor phase), because CaCO₃ decomposes during sintering to give CaO. Importantly, this XRD pattern (JH-052-117B) asserts that no reaction between CaCO₃ and the glass powder occurs at 750° C. (sintering cycle of 24 minutes), as no lines assigned to reaction products (i.e., CaSiO₃) were observed. Lastly, the XRD pattern of a post-leaching (JH-052-117C) sample shows only the vitreous phase, indicating full leachability of CaCO₃ and CaO by the acid. The weight loss of the sample powder was measured after the HCl treatment and found to be almost 20%, in accordance with the XRD which shows CaCO₃ as a major phase and CaO as a minor component.

Accordingly, a first aspect of the invention is a process for preparing a porous glass, comprising mixing borosilicate glass powder with calcium carbonate particles to form a mixture, sintering the mixture at a temperature in the range from 750° C. to 850° C., e.g., from 750° C. to 840° C., or from 750° C. to 825° C., to obtain a sintered body, cooling the sintered body and leaching calcium compounds (CaO, CaCO₃, Ca(OH)₂) from the cooled sintered body, e.g., with the aid of a mineral acid such as hydrochloric acid.

Prior to sintering, porous glass is made into geometrical shapes according to the intended use. Major uses include disk-shaped filters for a variety of applications (e.g., sand separation from water streams). To this end, the glass powder is pressed to form the desired shape, e.g., into disks of varying diameters and thicknesses, which then are sintered. In the experimental work reported below, mixtures consisting of the Pyrex®-type glass powder and calcium carbonate particles were mixed with a binder (such as 3% water solution of poly (vinyl alcohol) (PVA)) and the mixture was pressed into cylindrical pellets. Pellets were sintered in the desired temperature range and cooled to room temperature. Pellets were planned to be immersed in an acidic environment to leach out calcium carbonate. Much to our surprise, however, in many cases, the pellets produced were not strong enough to hold up under storage: breakdown of pellets was observed when the pellets were left in closed glass vials after a few days. A comparative study reported below, in which soda-lime container glass was used instead of Pyrex®-type glass, did not show a similar trend. Thus, the problem of Pyrex®-type glass/CaCO₃ pellets breakdown seems to be quite unique.

We solved the problem of poor mechanical stability of sintered bodies consisting of Pyrex®-type glass/CaCO₃ blend, imparting increased strength by modifying the cool down profile of the sintered bodies. That is, instead of letting the sintered bodies through a cool down to slowly reach room temperature, the sintered bodies were cooled to a temperature in the range from 300° C. to 500° C. and quenched. For example, by taking them out of the furnace, and immediately treating them with acid solution. Without wishing to be bound by theoretical explanations, experimental work conducted in support of this invention suggests that the poor mechanical strength of sintered bodies made of Pyrex®-type glass/CaCO₃ is due to the presence of calcium hydroxide, which is formed when the decomposition product of calcium carbonate, namely, carbon oxide, picks up water molecules from the atmosphere; the hydration of calcium oxide takes place at below 300° C. The sintered bodies are therefore quenched at temperature high enough to suppress the formation of calcium hydroxide, e.g., >200° C., or >300° C., for example, from 350 to 450° C. The need for a quenching procedure and the exact quenching temperature depends on the proportion in the blend. As shown below, X-ray powder diffraction analysis may assist in determining the exact conditions of this part of the process of the invention.

Accordingly, another aspect of the invention is a process for preparing a porous glass, comprising mixing borosilicate glass powder with calcium carbonate particles to form a mixture, processing the mixture into a desired geometrical shape under the application of pressure and optionally in the presence of a binder, sintering at a temperature in the range from 750 to 850° C. (e.g., 750 to 825° C.) to obtain a sintered body, wherein the cool down of the sintered bodies includes a step of quenching of the sintered body at a temperature high enough to suppress calcium hydroxide formation; and leaching calcium compounds from the quenched sintered body, e.g., with the aid of a mineral acid such as hydrochloric acid. The leaching takes place very shortly after the quenching (e.g., after not more than 1 to 10 minutes).

For convenience, the terms Pyrex®-type glass and the like are used interchangeably with borosilicate glass. Borosilicate glasses under the trademark Pyrex® were introduced in 1915 by the Corning Glass Works company. Similar compositions are made by other companies and for the purposes of the present invention all referred to as Pyrex®-type glass. By Pyrex®-type glass we mean SiO₂—B₂O₃—Na₂O glass, consisting of from 70 to 82 wt. % SiO₂ (e.g., 80.6%); from 9 to 15 wt. % B₂O₃(e.g., 12.6%); from 3 to 5 wt. % Na₂O (e.g., 4.2%); from 1 to 3 wt. % Al₂O₃(e.g., 2.2%) and minor amounts or traces of other oxides (e.g., CaO, MgO, and Fe₂O₃ and some chloride); Na₂O may be substituted for K₂O. The composition of both Corning 7740 and Schott 8330 is given as 80.6% SiO₂, 12.6% B₂O₃, 4.2% Na₂0, 2.2% Al₂O₃, 0.1% CaO, 0.1% Cl, 0.05% MgO, and 0.04% Fe₂O₃. Properties can be found at https://www.corning.com/catalog/cls/documents//selection-guides/CLS-GL-001.pdf. The known borosilicate glass called “DURAN” of the company Scott Glaswerke of Mainz, Germany, known as type number 8330 has the following properties: glass transition temperature (Tg) of this glass is 530° C., the softening temperature (Ts) (viscosity η of the glass is 10^{7.6} dPas) is 815° C. and the working temperature (η=10⁴ dPas) is 1270° C. according to U.S. Pat. No. 4,588,540.

The mixture of Pyrex® glass powder and calcium carbonate is proportioned in the range from 90:10 to 40:60 by weight, for example, from 80:20 to 60:40. The particle size distribution of the glass powder is important, as the experimental work reported below indicates that ball-milled glass which was sieved through 325 mesh screen gives very good results. Hence, Pyrex® glass powder, wherein the particles have a diameter in the range from 1 to 250 μm, e.g., from 1 to 70 μm, e.g., from 1 to 50 μm, e.g., from 1 to 45 μm, e.g., 1 to 10 μm, are suitable for use in the invention. As to the calcium carbonate additive, fine particles with an average diameter in the range from 1 to 10 μm are used.

The powder blend is processed to form, e.g., disk-like bodies, by dry compaction using a press, or by pelleting/pelletizing, namely, wet processes aided by a binder solution, in which the Pyrex® glass powder/calcium carbonate mixture is first wetted (e.g., volatile alcohol) and homogenized, the solvent is removed by evaporation and a binding solution is added and the mixture is subjected to particle size reduction and homogenization, i.e., wet milling the Pyrex® glass powder/calcium carbonate/binder mixture. The material is formed into cylindrical pellets through a dye or by using a rotary drum or disc pelletizer.

Suitable furnaces for sintering may include furnaces with quenching capabilities, by injection of cold air streams.

Leaching takes place with the aid of a strong mineral acid such as 1 to 20 wt. % hydrochloric acid or sulfuric acid (e.g., 2N-6N), by simply immersing the sintered bodies in the acidic solution for a sufficient time period. Organic acids may be used also for leaching.

The porosities of the pellets after leaching in an acid solution are high (36 to 62% calculated porosities) and are similar to porosities reported for the capillary suspension processing, about 50% open porosity (see J. Maurath et al., supra).

As mentioned above, barium carbonate and strontium carbonate were rejected as pore forming materials for Pyrex®-type glass because they react with the glass at a surprisingly low temperature, forming the corresponding metal silicate crystalline phases. It was observed that a similar reaction occurs between these alkaline earth metal oxides and a commercial amorphous silica. In contrast, a corresponding reaction with commercial quartz (a crystalline solid) advanced very slowly. The conventional wisdom in the art is that silicates of alkaline earth elements such as Ba-silicate are formed at high temperatures, above 1500° C. [M. Kerstan, C. Rissel, Barium silicates as high thermal expansion seals for solid oxide fuel cells studied by high-temperature X-ray diffraction (HT-XRD), J. Power Sources 196 (2011) 7578-7584].

Thus, another aspect of the invention relates to a process for the preparation of one or more alkaline earth metal silicates by reacting a vitreous material (such as amorphous silica or Pyrex®-type glass powder), and an alkaline earth carbonate, optionally in the presence of a transition metal or post-transition metal oxide, at a temperature lower than 1200° C., and even lower than 1100° C., e.g., <950° C., e.g., in the range from 850 to 950° C., to form a composite consisting of one or more alkaline earth metal silicates and a residual glass, and optionally recovering the one or more silicates.

The direct reaction product is often a silicate composite (by composite it is meant a mixture of one or more polycrystalline silicates and a residual glass; the content of the residual glass is <15 wt. %, e.g., <10 wt. % based on the total weight of the composite). The residual glass may be removed, e.g., by appropriate treatment in a solvent, acidic or basic solution, to recover substantially pure crystalline silicate phase(s). However, as discussed below, the glass component of the composite may have some benefits and for certain applications it may be retained.

The results indicate that the most reactive alkaline earth carbonate is BaCO₃, followed by SrCO₃ and CaCO₃. Binary silicate is formed when alkaline earth carbonate is reacted with Pyrex®-type glass powder at moderate temperatures as mentioned above. More complex silicates such as ternary and quaternary silicates are formed when transition metal oxides such as CuO and TiO₂ and post transition metal oxide such as SnO₂ are added to the alkaline earth carbonate and Pyrex-type glass powder.

Thus, preferred silicates have the formula MₐM_{b}^{I}Mu_{c}^{II}Si_{d}Oₑ, wherein: M is an alkaline earth metal Ca, Sr or Ba, and a is 1 or 2; M^{I} is a transition metal, and b is from 0 to 1, inclusive; M^{II} is a post transition metal, and c is from 0 to 1, inclusive; such that the sum of b and c equals 0 or 1; for example, 0.1<b≤1 and 0≤c<0.9.
d is an integer in the range from 1 to 5, inclusive; and
e is an integer in the range from 3 to 10, inclusive.

The reaction proceeds effectively by forming a mixture consisting of vitreous material (e.g., Pyrex®-type glass powder), alkaline earth carbonate and optionally other oxides, having particle size distributions as set out above, creating a homogenous mixture with a reduced particle size by milling the mixture in the presence of a liquid, e.g., lower alcohol, thereby forming a finely ground mixture, removing the liquid and heat treating the mixture at a temperature in the range from 850 to 950 for at least one hour. More than one cycle of wet milling may be carried out (e.g., the first one in the presence of an alcohol and the second one in the presence of a binder solution).

The silicates obtained by the invention possess useful properties.

For example, the composite consisting of sanbornite (BaSi₂O₅) and residual glass, formed by the reaction between BaCO₃ and Pyrex®-type glass powder at 850-950° C. range, has high thermal expansion.

This high expansion composite may be useful for solid oxide fuel cells (SOFC), high expansion low temperature cofired ceramics (LTCC) and other sealing operations.

Other examples involve the incorporation of Cu into the metal silicate. When CuO was added to the alkaline earth carbonate and Pyrex®-type glass powder and heated at a moderate temperature of 900° C. for a very short time of 1 hour in air, unexpected composite silicates were obtained. Processing a mixture consisting of BaCO₃, CuO and Pyrex®-type glass powder in the manner described above affords two silicate composites: BaCuSi₂O₆ (Colinowensite, also known as the ancient Han purple pigment) and BaCuSi₄O₁₀ (Effenbergerite, also known as the ancient Han blue pigment). When CaCO₃, CuO and Pyrex®-type glass powder were processed similarly (900° C. for a very short time of 1 hour in air), the mineral CaCuSi₄O₁₀ composite (Cuprorivaite, also known as the very ancient Egyptian blue pigment) was obtained. When SrCO₃, CuO and Pyrex®-type glass powder were processed under the abovementioned conditions (900° C. for a very short time of 1 hour in air), a mineral composite SrCuSi₄O₁₀ (Wesselsite) was obtained. Three composites BaCuSi₄O₁₀, SrCuSi₄O₁₀ and CaCuSi₄O₁₀ have a blue color and the BaCuSi₂O composite has a purple color. Because of their color and the residual glass all these materials are candidates for ceramic blue pigments, other pigment applications and mid IR reflecting compositions.

Another type of ternary silicate composite was obtained when BaCO₃, TiO₂ and Pyrex®-type glass powder were processed at 950° C. for a short time of 1 hour to give the mineral composite Ba₂TiSi₂O₆ (Fresnoite). A quaternary silicate composite BaTi_{0.25}Sn_{0.75}Si₃O₉ (Pabstite) was obtained by processing the stoichiometric amounts of barium carbonate, titanium oxide, tin oxide and Pyrex®-type glass at 950° C. for a first period of time (e.g., one hour) and at 1100° C. for a second period of time (e.g., eight hours).

### BRIEF DESCRIPTION OF THE FIGURES

FIG. 1 shows XRD patterns of 20 wt. % CaCO₃ mixture with ball milled Pyrex®-type powder before sintering (sample code JH-052-117A), after sintering at 750° C. (sample code JH-052-117B) and after leaching the sintered sample in HCl solution (sample code JH-052-117C).

FIG. 2 shows an XRD pattern of 20 wt. % CaCO₃ in ball-milled soda lime container glass after sintering at 700° C. and leaching in HCl solution (sample code JH-053-86A1).

FIG. 3 shows XRD patterns of 30 wt. % CaCO₃ in ball-milled soda lime container glass after pressing (sample code JH-053-78), after sintering at 700° C. (sample code JH-053-78B) and after leaching the sintered pellet in HCl solution (sample code JH-053-78C1).

FIG. 4 shows an XRD pattern of an unbroken pellet made of 30 wt. % CaCO₃ and ball milled Pyrex®-type glass, after sintering at 850° C. (sample code JH-054-7B2).

FIG. 5 shows an XRD pattern of broken pellet made of 30 wt. % CaCO₃ and ball milled Pyrex®-type glass, after sintering at 775° C. (sample code JH-054-7B11).

FIGS. 6A-6D and 7A-7D present SEM images (1000 and 5000 magnifications, respectively) of four pellets of Table 7 which were prepared with 20 wt. % (Example 73; JH-054-8A16), 30 wt. % (Example 76; JH-054-8B16), 40 wt. % (Example 79; JH-054-8C16) and 50 wt. % (Example 82; JH-054-8D21) CaCO₃.

FIG. 8 shows an XRD pattern of the pellet of Example 85, made of 50 wt. % BaCO₃ and 50 wt. % Pyrex®-type glass after sintering at 850° C. (sample code JH-054-13D-8).

FIG. 9 shows an XRD pattern of the pellet of Example 86, made of 50 wt. % SrCO₃ and 50 wt. % Pyrex®-type glass after sintering at 850° C. (sample code JH-054-22D-5).

FIG. 10 shows an XRD pattern of Example 87, the reaction product of ball milled Pyrex®-type glass powder and BaCO₃ at 850° C. (sample code JH-052-127).

FIG. 11 shows an XRD pattern of Example 88, the reaction product of amorphous silica and BaCO₃ at 850° C. (sample code JH-052-129A).

FIG. 12 shows an XRD pattern of Example 89, the reaction product of quartz and BaCO₃ at 850° C. (sample code JH-052-129B).

FIG. 13 shows an XRD pattern of Example 90 (sample code JH-054-48), indicating BaCuSi₂O₆ formation.

FIG. 14 shows an XRD pattern of Example 91 (sample code JH-054-49), indicating BaCuSi₄O₁₀ formation.

FIG. 15 shows an XRD pattern of Example 92 (sample code JH-054-50), indicating CaCuSi₄O₁₀ formation.

FIG. 16 shows an XRD pattern of Example 93 (sample code JH-054-73), indicating SrCuSi₄O₁₀ formation.

FIG. 17 shows an XRD pattern of Example 94 (sample code JH-056-9B1), indicating BaTi_{0.25}Sn_{0.75}Si₃O₉ formation.

FIG. 18 shows an XRD pattern of Example 95 (sample code JH-056-11), indicating Ba₂TiSi₂O₈ formation.

FIG. 19 shows an XRD pattern of a bar made of ball milled Pyrex-type glass and BaCO₃ powder sintered at 900° C. for 1 hour, Example 96 (sample code JH-054-38).

FIG. 20 shows a dilatogram of the bar sintered at 900° C. for 1 hour, Example 96 (sample code JH-054-38).

FIG. 21 shows an XRD pattern of a bar made of Pyrex®-type glass sintered at 900° C. for 1 hour, Example 97 (sample code JH-054-66).

FIG. 22 shows an XRD pattern of a bar prepared by modified procedure and sintered at 900° C., Example 98 (sample code JH-054-87).

FIG. 23 shows an XRD spectrum of bar prepared by a modified procedure and sintered at 950° C., Example 99 (sample code JH-054-88).

FIG. 24 shows an XRD pattern of a bar prepared by a modified procedure and sintered at 850° C., Example 100 (sample code JH-054-90).

FIG. 25 shows a dilatogram of the 3^{rd} run of a bar prepared by a modified procedure and sintered at 900° C., Example 98B (sample code JH-054-87B).

FIG. 26 shows a dilatogram of the 3^{rd} run of a bar prepared by a modified procedure and sintered at 850° C., Example 100B (sample code JH-054-90B).

FIG. 27 shows a dilatogram of the 3^{rd} run of a bar prepared by a modified procedure and sintered at 950° C., Example 99B (sample code JH-054-92B).

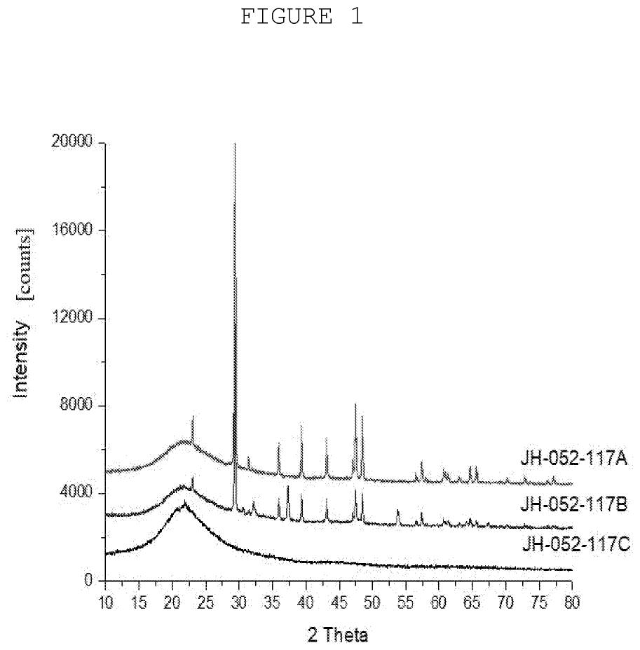

### EXAMPLES

Materials and Methods

Ethanol (96%), Isopropanol (abs.), Poly Vinyl Alcohol (99%), Hydrochloric acid (37%), CaCO₃ (99%), and SrCO₃ (98%) were purchased from Sigma-Aldrich, BaCO₃ (minimum assay 99.5%) from BDH Chemicals LTD. (AnalaR, Lot #: 6546190), amorphous SiO₂ was purchased from Alfa Aeasar (Lot #: C09Q03) and quartz silica from Cerac (Lot #: X0029011). All of the chemicals were used without further purification.

The present invention was demonstrated using waste pieces of Pyrex®-type or soda lime container (bottle) glasses.

Pressing of the powder was performed using precision press tool model 8, die diameter 8 mm of P. O. Weber GmbH, and manual Carver press. The pressure used was 3000-3500 psi.

Calculation Methods

1) Density

The accuracy of the digital micrometer is ±0.01 mm and the weight accuracy is ±0.0001 g therefore the error in the density measurement (ρ=m/v=m/(IIr²h), where m is pellet mass, r radius of pellet and h is thickness of pellet) Δρ/ρ=Δm/m+2Δr/r+Δh/h is estimated 1-2% for typical pellet's weight and dimensions, m=0.2 g; r=3.5 mm and h=2 mm.

2) Total Porosity (TP)

The total porosity (TP) was calculated from the apparent density (ρₐₚₚ, measured from weight and dimensions of the pellet) and the density of Pyrex®-type glass 2.24 g/cm³ or the density of soda lime container glass 2.42 g/cm³:

TP(%)=(1−ρₐₚₚ/ρ_{pyrex®})×100

Analytical Methods:

1) X-Ray Diffraction (XRD)

Phase formation due to reaction with pore forming materials (MCO₃ where M=Ca, Sr, Ba) and heat treatment were measured by XRD Powder Diffractometer Empyrean (Panalytical B. V., Almelo, the Netherlands) equipped with position sensitive detector X′Celerator. Data were collected in the θ/2θ geometry using Cu Kₐ radiation (λ=1.54178 Å) at 40 kV and 30 mA. Scans were run for ˜15 min in a 2θ range of 10-60° with a step equal to ˜0.03°.

2) Surface Area

The surface area was measured by the BET method using Quantachrome Nova Touch LX3. The surface area of ball milled Pyrex®-type glass powder was 2.12 m²/g and the surface area of CaCO₃ was 2.87 m²/g.

3) Porous Structure

The porous structure was investigated by a Scanning electron Microscope (SEM). Model: Quanta 200 FEI Company with Backscattered Electrons SEM imaging, Secondary Electrons SEM imaging, and Energy dispersive X-ray spectroscopy (EDS).

4) Dilatometry

Dilatometry testing for linear coefficient of expansion was performed on Orton dilatometer 1000D.

### Preparations 1 to 4

### Preparations of Glass Powders

1) 60 Mesh Pyrex®-Type Glass

Pieces of Pyrex®-type glasses were washed with water, rinsed with ethanol, and crushed into powder with a stainless steel pestle and mortar. The powder was sieved through a 60 mesh screen (250 microns).

2) 60 Mesh Soda Lime Container Glass

Pieces of soda lime container (bottle) glasses were washed with water, rinsed with ethanol, and crushed into powder on a stainless steel pestle and mortar. The powder was sieved through a 60 mesh screen (250 microns).

3) Ball Milled Pyrex®-Type Glass

60 mesh powder of Pyrex®-type glasses was ball milled with isopropanol for 24 hours and the glass slip was sieved through a 325 mesh screen. After evaporation of isopropanol, the powder was dried in an oven at 100° C.

4) Ball Milled Soda Lime Container Glass

60 mesh powder of soda lime container glass was ball milled with isopropanol for 24 hours and the glass slip was sieved through a 325 mesh screen. After evaporation of isopropanol, the powder was dried in an oven at 100° C.

### Examples 1-18 (Reference)

### Sintering of Glass Powder (without CaCO₃)

The glass powders of preparations 1-4 were sintered without the pore forming material (i.e., CaCO₃). Table 1 collects data (processing temperature, average apparent density and estimated total porosity) for all four types of glass powders.

TABLE 1
Sintering and total porosity data for 4 types of glass powder
at 625° C.-775° C. temperature range

| | Powder | Processing | ρₐₚₚ average, | T.P. |
|---|---|---|---|---|
| Example | preparation | Temp., ° C. | g/cm³ | average, % |
| 1 | 1 | 700 | 1.58 | 28.3 |
| 2 | 1 | 725 | 1.70 | 22.9 |
| 3 | 1 | 750 | 1.82 | 17.7 |
| 4 | 1 | 775 | 1.92 | 12.7 |
| 5 | 2 | 625 | * | * |
| 6 | 2 | 650 | 1.79 | 29.1 |
| 7 | 2 | 675 | 1.86 | 26.1 |
| 8 | 2 | 700 | 2.15 | 14.7 |
| 9 | 3 | 625 | 1.32 | 40.8 |
| 10 | 3 | 650 | 1.33 | 40.4 |
| 11 | 3 | 675 | 1.34 | 39.9 |
| 12 | 3 | 700 | 1.60 | 28.5 |
| 13 | 3 | 725 | 1.77 | 20.6 |
| 14 | 3 | 750 | 2.05 | 8.1 |
| 15 | 3 | 775 | 2.07 | 7.2 |
| 16 | 4 | 650 | 1.51 | 40.1 |
| 17 | 4 | 675 | 1.92 | 23.6 |
| 18 | 4 | 700 | 2.41 | 4.4 |

* disks were broken during the measurement; this is an indication of poor sintering.

As seen from Table 1, ball milled Pyrex®-type powder practically does not sinter in the 625° C.-675° C. temperature range, almost no change in apparent density and estimated total porosity.

Sintering increases above 675° C. and at 750° C.-775° C. range, sintering is enhanced with small total porosity. Useful porosity range is limited to 675° C.<T<750° C. temperature range and total porosity is <300. As expected, the sintering of 60 mesh Pyrex®-type glass is shifted to higher temperatures relative to ball milled Pyrex®-type glass because of its smaller surface area. Similar behavior is shown by the soda lime container glass, ball milled glass powder sinters at lower temperatures in comparison to 60 mesh powder. The examples devoid of the use of pore forming material were done to obtain information for the processing of powders with pore forming materials.

### Preparations 5 and 6 (Reference) and 7 to 10 (Invention) Pelletizing Mixtures of Glass Powders and CaCO₃

5) Pellets of Ball Milled Soda Lime Container Glass+20% CaCO₃

Ball milled soda lime container glass powder (preparation 4) was mixed with fine (1-10 μm) CaCO₃ powder (percentage of 20% by weight) and ground together with isopropanol in an agate mortar and pestle to homogenize the mixture. After evaporation of isopropanol, 3% PVA solution in water (as a binder) was added to the dry mixture and the mixture was ground again in agate pestle and mortar to obtain uniform distribution of PVA in the powder. After PVA addition the powder (about 0.2 g) was pressed by precision press tool and manually by Carver press to obtain three pellets.

6) Pellets of Ball Milled Soda Lime Container Glass+30% CaCO₃

Ball milled soda lime container glass powder (preparation 4) was mixed with fine (1-10 μm) CaCO₃ powder (percentage of 30% by weight) and ground together with isopropanol in an agate mortar and pestle to homogenize the mixture. After evaporation of isopropanol, 3% PVA solution in water (as a binder) was added to the dry mixture and the mixture was ground again in agate pestle and mortar to obtain uniform distribution of PVA in the powder. After PVA addition the powder (about 0.2 g) was pressed by precision press tool and manually by Carver press to obtain three pellets.

7-10) Pellets of ball milled Pyrex®-type glass with CaCO₃

Ball milled Pyrex®-type glass powder (of preparation 3) was mixed with fine (1-10 mμ CaCO₃ powder (20 wt. %-preparation 7; 30 wt. % preparation 8; 40 wt. %-preparation 9; 50 wt. %-preparation 10) and ground together with isopropanol in an agate mortar and pestle to homogenize the mixture. After evaporation of isopropanol, 3% PVA solution in water (as a binder) was added to the dry mixture and the mixture was ground again in agate pestle and mortar to obtain uniform distribution of PVA in the powder. After PVA addition the powder (about 0.2 g) was pressed by precision press tool and manually by Carver press to obtain three pellets for each of preparations 7 to 10.

### Examples 19-24 (Reference)

### Sintering of Pellets Consisting of Ball Milled Soda Lime Container Glass and CaCO₃

Based on data of Examples 1-18, ball milled soda lime container glass with pore forming CaCO₃ was sintered at temperatures above 675° C.

The pellets of preparations 5 and 6 (3 pellets of every preparation) were placed on platinum foil and heated in a furnace according to the next scheme: gradient of 20° C./min for ramp to maximum temperature (sintering temperature), dwell of 24 minutes at maximum temperature and cool down with gradient 20° C./min.

After cool down, the pellets were weighted (analytical balance) and measured (with digital micrometer) and the weight and dimensions were recorded. For some compositions, pellets were immersed in 1:1 HCl solution at 80° C. for 4 hours.

After leaching in the acid, the pellets were washed with deionized water, dried in an oven and their weight and dimensions were recorded.

The densities and total porosities of pellets consisting of CaCO₃ and ball milled container glass after sintering and leaching in HCl solution are shown in Table 2.

TABLE 2

| | | | | | Average |
|---|---|---|---|---|---|
| | | | | Average ρₐₚₚ | T.P. after |
| | | Proc. | Average | after HCL | HCl |
| Example and | Pellet | Temp., | ρₐₚₚ, | leaching, | leaching, |
| sample code | prep. | ° C. | g/cm³ | g/cm³ | % |
| 19, JH-053-75G-I | 5 | 675 | 1.73 | no treatment | — |
| 20, JH-053-75D-F | 5 | 685 | 1.89 | 1.68 | 33.30 |
| 21, JH-053-75A-C | 5 | 700 | 2.11 | 1.98 | 21.43 |
| 22, JH-053-78G-I | 6 | 675 | 1.74 | 1.31 | 48.22 |
| 23, JH-053-78D-F | 6 | 685 | 1.86 | 1.36 | 46.23 |
| 24, JH-053-78A-C | 6 | 700 | 1.95 | 1.43 | 43.26 |

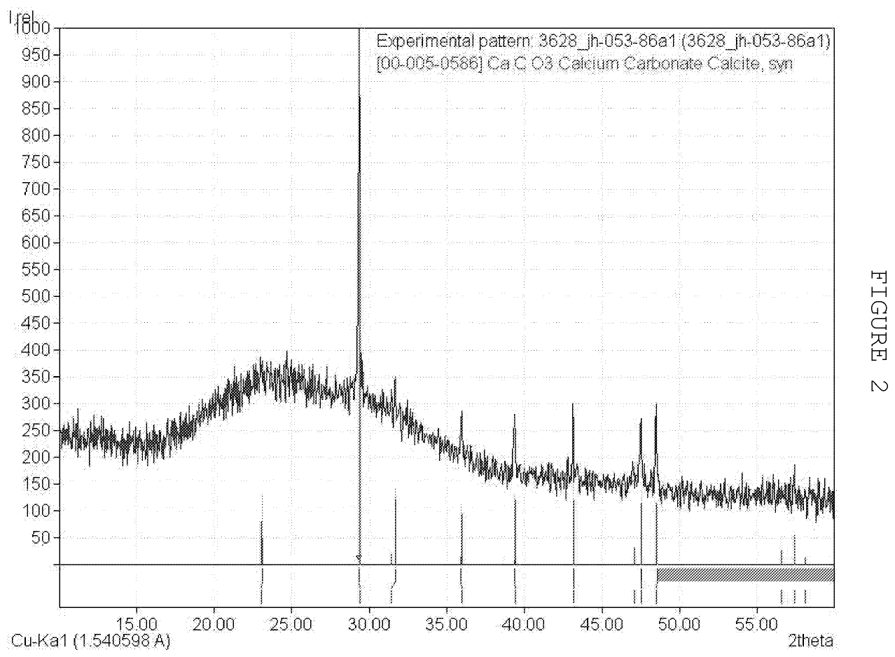

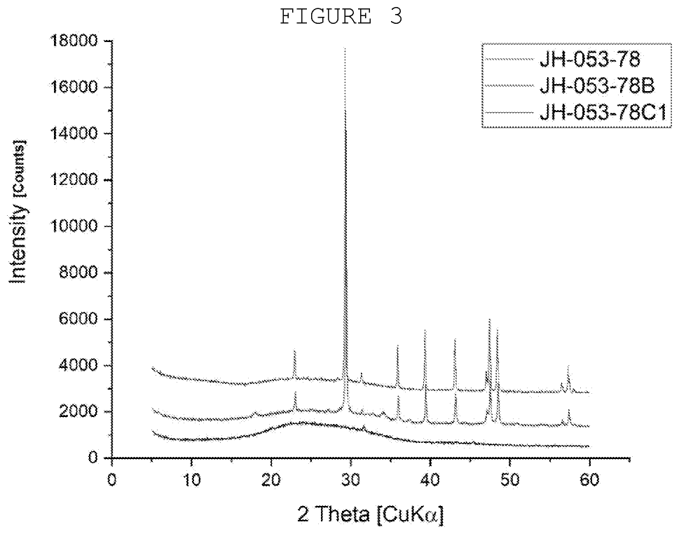

According to data from Table 2, well sintered pellets were obtained. Apparent densities were recorded after sintering and in some temperatures (685 and 700° C. for 20 wt. % of CaCO₃) also after leaching in HCl solution. All the pellets with 30 wt. % CaCO₃ were treated with HCl solution. Total porosity increases with the decrease in sintering temperature. 20 wt. % of CaCO₃ pellets sintered at 675° C. were not treated with HCl solution and were kept as a control for assessment of the pellet's stability. After 15 months the dimensions and weights of these pellets were recorded and compared with initial values, no change in dimensions and weights (within experimental error) were found. Pellets with 30 wt. % of CaCO₃ have higher porosities after HCl leaching and the trend of porosity increase with a decrease in sintering temperature discussed above for the 20 wt. % of CaCO₃, is maintained with a moderate increase. FIG. 2 shows the XRD pattern of a pellet containing 20 wt. % CaCO₃ and ball milled soda lime container glass after sintering at 700° C. and after leaching in HCL solution, indicating that a portion of CaCO₃ did not dissolve. XRD patterns of samples with 30 wt. % CaCO₃, i.e., the pellet of Preparation 6 (JH-053-78), the sintered pellet of Example 24 (JH-053-78B) and the post-leaching pellet (JH-053-78C1) are shown in FIG. 3. FIGS. 2 and 3 show that pellets with 20 wt. % of CaCO₃ behave differently than pellets with 30 wt. % of CaCO₃.

### Examples 25-72 (Comparative)

### Sintering of Pellets Consisting of Ball Milled Pyrex®-Type Glass and CaCO₃

The pellets of preparations 7 to 10 (three pellets of each preparation) were placed on platinum foil and heated in a furnace according to the following scheme: gradient of 20° C./min for ramp to maximum temperature (sintering temperature), dwell of 24 minutes at maximum temperature and cool down with gradient 20° C./min.

In view of the data shown in Table 1, four sintering temperatures were chosen for the study (775° C., 800° C., 825° C., and 850° C., and twelve pellets were heat-treated at each run, i.e., at each sintering temperature (three for preparation 7-20% of CaCO₃; three for preparation 8-30% of CaCO₃; three for preparation 9-40% of CaCO₃ and three for preparation 10-50% of CaCO₃). Hence, a total number of forty-eight pellets were sintered.

After cool down, the pellets were weighted (analytical balance) and measured (with digital micrometer) and the weight and dimensions were recorded. The data for pellets made of ball milled Pyrex®-type glass with 20 wt. % of CaCO₃ (Preparation 7) are in Table 3, for 30 wt. % of CaCO₃ (Preparation 8) are in Table 4, for 40 wt. % of CaCO₃ (Preparation 9) are in Table 5 and for 50 wt. % of CaCO₃ (Preparation 10) are in Table 6.

TABLE 3
Ball milled Pyrex ®-type glass with 20 wt. % of CaCO₃

| | Sintering Temp., | | | | |
|---|---|---|---|---|---|
| Example | ° C. | d, mm | h, mm | m, g | ρₐₚₚ, g/cm³ |
| 25 | 850 | 6.747 | 2.464 | 0.1695 | 1.924 |
| 26 | 850 | 6.681 | 2.174 | 0.1523 | 1.991 |
| 27 | 850 | 6.740 | 2.632 | 0.1757 | 1.871 |
| 28 | 825 | 6.877 | 2.629 | 0.1796 | 1.839 |
| 29 | 825 | 6.939 | 2.616 | 0.1792 | 1.812 |
| 30 | 825 | 6.859 | 2.521 | 0.1731 | 1.858 |
| 31 | 800 | 7.330 | 2.704 | 0.1760 | 1.543 |
| 32 | 800 | 7.289 | 2.749 | 0.1788 | 1.559 |
| 33 | 800 | broken | broken | broken | broken |
| 34 | 775 | broken | broken | broken | broken |
| 35 | 775 | broken | broken | broken | broken |
| 36 | 775 | broken | broken | broken | broken |

TABLE 4
Ball milled Pyrex ®-type glass with 30 wt. % of CaCO₃

| | Sintering | | | | |
|---|---|---|---|---|---|
| Example and | Temp., | | | | ρₐₚₚ, |
| sample code | ° C. | d, mm | h, mm | m, g | g/cm³ |
| 37 | 850 | 6.752 | 1.746 | 0.1209 | 1.933 |
| 38 JH-054-7B2 | 850 | 6.868 | 2.707 | 0.1924 | 1.918 |
| 39 | 850 | 6.845 | 2.335 | 0.1573 | 1.831 |
| 40 | 825 | broken | broken | broken | broken |
| 41 | 825 | 7.175 | 2.491 | 0.1643 | 1.631 |
| 42 | 825 | 7.135 | 2.440 | 0.1663 | 1.705 |
| 43 | 800 | broken | broken | broken | broken |
| 44 | 800 | broken | broken | broken | broken |
| 45 | 800 | 7.533 | 2.728 | 0.1670 | 1.374 |
| 46 | 775 | broken | broken | broken | broken |
| 47 JH-054-7B11 | 775 | broken | broken | broken | broken |
| 48 | 775 | broken | broken | broken | broken |

TABLE 5
Ball milled Pyrex ®-type glass with 40 wt. % of CaCO₃

| | Sintering Temp., | | | | |
|---|---|---|---|---|---|
| Example | ° C. | d, mm | h, mm | m, g | ρₐₚₚ, g/cm³ |
| 49 | 850 | 6.922 | 2.118 | 0.142 | 1.782 |
| 50 | 850 | 6.881 | 1.944 | 0.1406 | 1.945 |
| 51 | 850 | 6.841 | 1.907 | 0.1335 | 1.905 |
| 52 | 825 | 7.370 | 2.177 | 0.1480 | 1.593 |
| 53 | 825 | 7.515 | 2.155 | 0.1454 | 1.521 |
| 54 | 825 | 7.349 | 2.086 | 0.1444 | 1.632 |
| 55 | 800 | broken | broken | broken | broken |
| 56 | 800 | broken | broken | broken | broken |
| 57 | 800 | broken | broken | broken | broken |
| 58 | 775 | broken | broken | broken | broken |
| 59 | 775 | broken | broken | broken | broken |
| 60 | 775 | broken | broken | broken | broken |

TABLE 6
Ball milled Pyrex ®-type glass with 50 wt. % of CaCO₃

| | Sintering Temp., | | | | |
|---|---|---|---|---|---|
| Example | ° C | d, mm | h, mm | m, g | ρₐₚₚ, g/cm³ |
| 61 | 850 | 7.149 | 1.927 | 0.1355 | 1.751 |
| 62 | 850 | 7.205 | 1.940 | 0.1361 | 1.721 |
| 63 | 850 | 7.224 | 1.662 | 0.1166 | 1.712 |
| 64 | 825 | broken | broken | broken | broken |
| 65 | 825 | broken | broken | broken | broken |
| 66 | 825 | broken | broken | broken | broken |
| 67 | 800 | broken | broken | broken | broken |
| 68 | 800 | broken | broken | broken | broken |
| 69 | 800 | broken | broken | broken | broken |
| 70 | 775 | broken | broken | broken | broken |
| 71 | 775 | broken | broken | broken | broken |
| 72 | 775 | broken | broken | broken | broken |

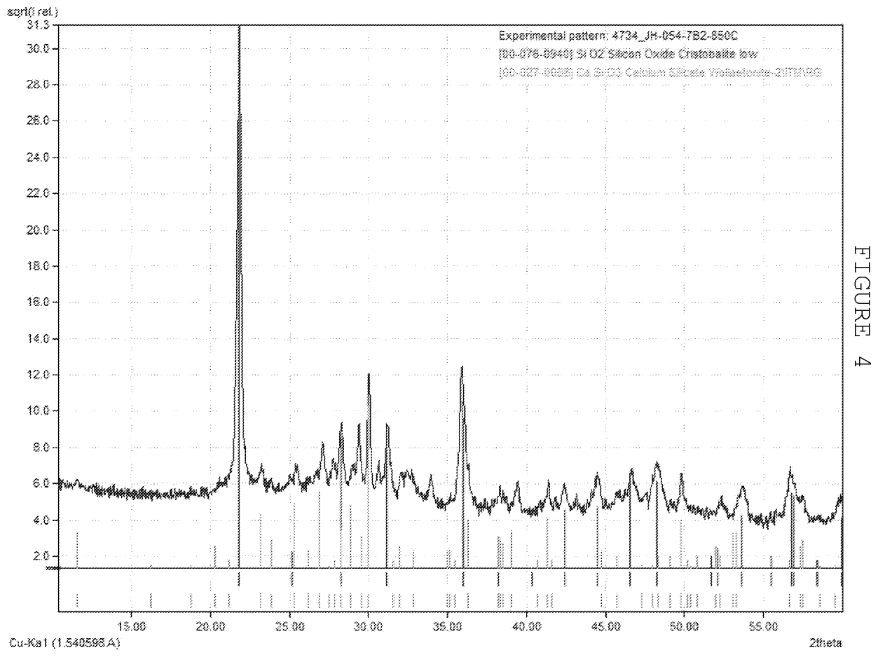

At a temperature of 850° C. mechanically strong pellets were obtained. However, the presence of a reaction product between the glass and calcium carbonate, namely CaSiO₃, was detected by XRD analysis in the samples. FIG. 4 shows an XRD pattern of a sample consisting of an unbroken pellet of Example 38 (JH-054-7B2), in which a characteristic peak at position 30° 2θ, assigned to CaSiO₃, was observed. Thus, a temperature of 850° C. was too high to suppress the reaction of calcium carbonate with the glass under the test conditions.

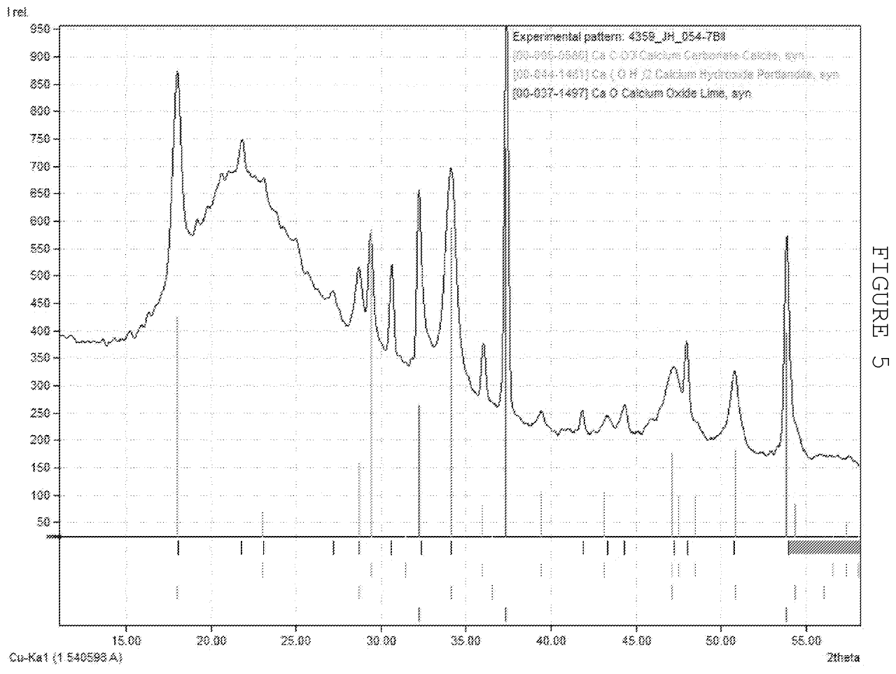

Unfortunately, sintering the pellets at a lower temperature, i.e., at a temperature equal to, or lower than, 825° C., to prevent the reaction between the glass and calcium carbonate, afforded mechanically weak pellets. When the pellets were taken out of the furnace, they were cylindrical in shape and strong, and their weights and dimensions could be recorded. When left in closed glass vials for several days some of them turned into powder. The results tabulated in Tables 3 to 6 indicate that the number of broken pellets increases with an increase in the concentration of CaCO₃ in the pellets and with a decrease in sintering temperature. XRD analysis of a sample consisting of a broken pellet of Example 47 (JH-054-7B11), which was sintered at 775° C., revealed new peaks located at positions ˜18° and ˜34° 2θ, assigned to Ca(OH)₂ (FIG. 5). Ca(OH)₂ phase was not detected in the XRD patterns of the mechanically strong pellets sintered at 850° C., suggesting that the presence of Ca(OH)₂ accounts for the breakage of the pellets produced in the 600-800° C. temperature range. Across this temperature range, calcium carbonate decomposes to give calcium oxide and carbon dioxide:

CaCO₃→CaO+CO₂

Without wishing to be bound by theoretical explanation, it is suspected that calcium oxide, owing to its high reactivity, can pick up water molecules from the atmosphere at a temperature lower than 300° C., to form Ca(OH)₂, which has a smaller density (2.343 g/cm³) than CaO (3.346 g/cm³). Formation of Ca(OH)₂ from CaO causes expansion (volume increase of about 43%) and generates high stress which can lead to the breakage of sintered pellet.

### Examples 73-84 (of the Invention)

### Sintering of Pellets Consisting of Ball Milled Pyrex®-Type Glass and CaCO₃ at 800° C., Quenching at 400° C. Followed by Immediate Leaching

The pellets of preparations 7 to 10 (three pellets of each preparation) were placed on platinum foil and heated in a furnace according to the next scheme: gradient of 20° C./min for ramp to 800° C. sintering temperature, dwell of 24 minutes at maximum temperature and cool down with gradient 20° C./min to 400° C. and quenching (the pellets were taken out of the furnace at 400° C.) and immediately immersed in the 1:1 HCl solution at 80° C. for 4 hours. This procedure does not allow sufficient time for Ca(OH)₂ formation, thus all CaO and traces of Ca(OH)₂, if formed, are dissolved.

After cool down, the pellets were weighted (analytical balance) and measured (with digital micrometer) and the weight and dimensions were recorded.

The data (dimensions, weights, apparent densities, and total porosity) for pellets consisting of ball milled Pyrex®-type glass powder and CaCO₃ (Preparations 7-10) sintered at 800° C., quenched at 400° C. and leached with HCl solution is shown in Table 7.

TABLE 7

| Example and | CaCO₃, | | | | ρₐₚₚ, | T.P., |
|---|---|---|---|---|---|---|
| sample code | wt. % | d, mm | h, mm | m, g | g/cm³ | % |
| 73 JH-054-8A16 | 20 | 7.129 | 2.544 | 0.1442 | 1.42 | 36.3 |
| 74 | 20 | 7.138 | 2.584 | 0.1468 | 1.42 | 36.3 |
| 75 | 20 | 7.100 | 2.599 | 0.1467 | 1.43 | 36.1 |
| 76 JH-054-8B16 | 30 | 7.381 | 2.563 | 0.1313 | 1.20 | 46.3 |
| 77 | 30 | 7.267 | 2.607 | 0.1320 | 1.22 | 45.3 |
| 78 | 30 | 7.216 | 2.572 | 0.1316 | 1.25 | 43.9 |
| 79 JH-054-8C16 | 40 | 7.529 | 2.196 | 0.0994 | 1.02 | 54.4 |
| 80 | 40 | 7.534 | 2.247 | 0.1026 | 1.02 | 54.4 |
| 81 | 40 | 7.540 | 2.248 | 0.1045 | 1.04 | 53.3 |
| 82 JH-054-8D21 | 50 | 7.590 | 2.248 | 0.0878 | 0.86 | 61.3 |
| 83 | 50 | 7.654 | 2.319 | 0.0898 | 0.84 | 62.3 |
| 84 | 50 | 7.488 | 2.036 | 0.0792 | 0.88 | 60.4 |

It is seen that no pellets breakdown occurred, across the 20-50 wt. % CaCO₃ concentration levels. The porosities of the pellets after leaching in an acid solution are high (36 to 62% calculated porosities).

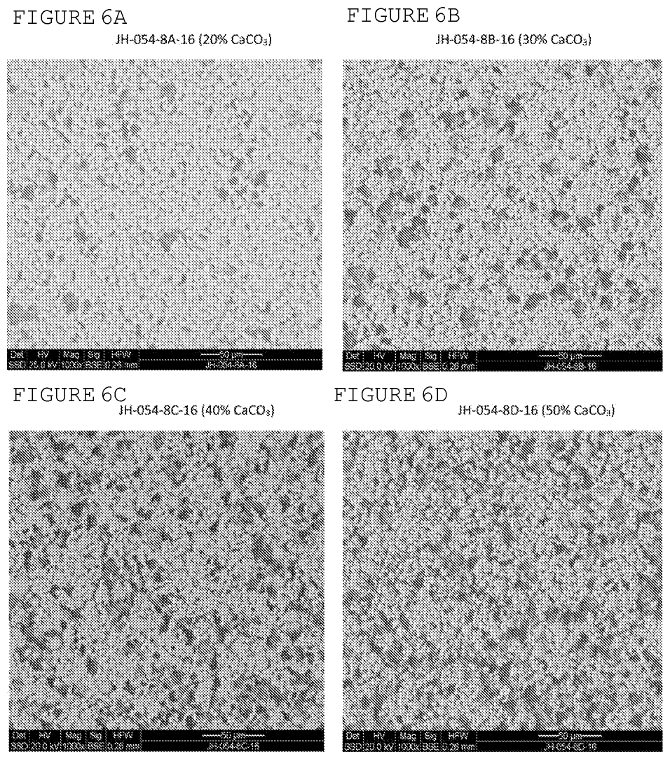

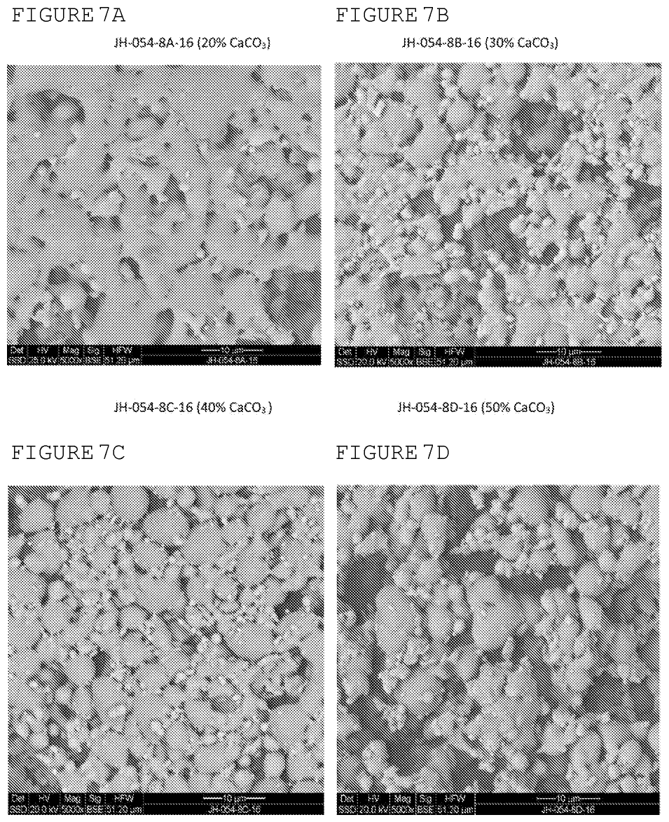

FIGS. 6A-6D and 7A-7D present SEM images (1000 and 5000 magnifications, respectively) of four pellets of Table 7 which were prepared with 20 wt. % (Example 73; JH-054-8A16), 30 wt. % (Example 76; JH-054-8B16), 40 wt. % (Example 79; JH-054-8C16) and 50 wt. % (Example 82; JH-054-8D21) CaCO₃. The SEM images show that porosity increases with increasing concentration of CaCO₃. Sintering extent also increases in the order 20>30>40>50 wt. CaCO₃.

### Preparations 11 to 12 (Comparative)

### Preparations of BaCO₃ and SrCO₃-Containing Pellets

11) Pellets of Ball Milled Pyrex®-Type Glass with 50 wt %. BaCO₃

Ball milled Pyrex-type glass powder (preparation 3) was mixed with fine 50 wt. % BaCO₃ and ground together with isopropanol in an agate mortar and pestle to homogenize the mixture. After evaporation of isopropanol, 3% PVA solution in water (as a binder) was added to the dry mixture and the mixture was ground again in agate pestle and mortar to obtain uniform distribution of PVA in the powder. After PVA addition the powder (about 0.2 g) was pressed by precision press tool and manually by Carver press to obtain three pellets of composition for preparation 11.

12) Pellets of Ball Milled Pyrex®-Type Glass with 50 wt %. SrCO₃

Ball milled Pyrex-type glass powder (preparation 3) was mixed with fine 50 wt. % SrCO₃ and ground together with isopropanol in an agate mortar and pestle to homogenize the mixture. After evaporation of isopropanol, 3% PVA solution in water (as a binder) was added to the dry mixture and the mixture was ground again in agate pestle and mortar to obtain uniform distribution of PVA in the powder. After PVA addition the powder (about 0.2 g) was pressed by precision press tool and manually by Carver press to obtain three pellets of composition for preparation 12.

### Example 85 (Comparative)

### Sintering of Pellets Consisting of Ball Milled Pyrex®-Type Glass and BaCO₃

The three pellets of preparation 11 were placed on platinum foil and heated in a furnace according to the next scheme: gradient of 20° C./min for ramp to 850° C. sintering temperature, dwell of 24 minutes at maximum temperature and cool down with gradient of 20° C./min.

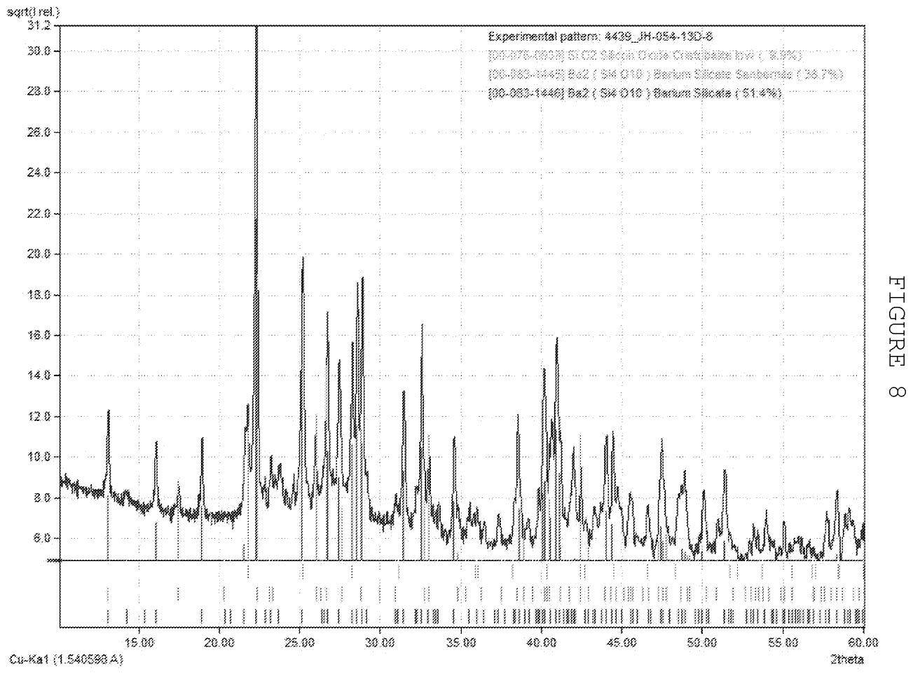

The XRD pattern of the sintered pellet is shown in FIG. 8. The XRD pattern shows that BaSi₂O₅ (Sanbornite) was the main crystalline phase formed, with some cristobalite. No BaCO₃ was left and the hump of the glass at about 25° 2θ disappeared, suggesting that the reaction between BaCO₃ and the glass occurred and went to completion. Residual glass, if present, is probably not a Pyrex® glass; it may not be vitreous but still amorphous.

### Example 86 (Comparative)

### Sintering of Pellets Consisting of Ball Milled Pyrex®-Type Glass and SrCO₃

The three pellets of preparation 12 were placed on platinum foil and heated in a furnace according to the next scheme: gradient of 20° C./min for ramp to 850° C. sintering temperature, dwell of 24 minutes at maximum temperature and cool down with gradient of 20° C./min.

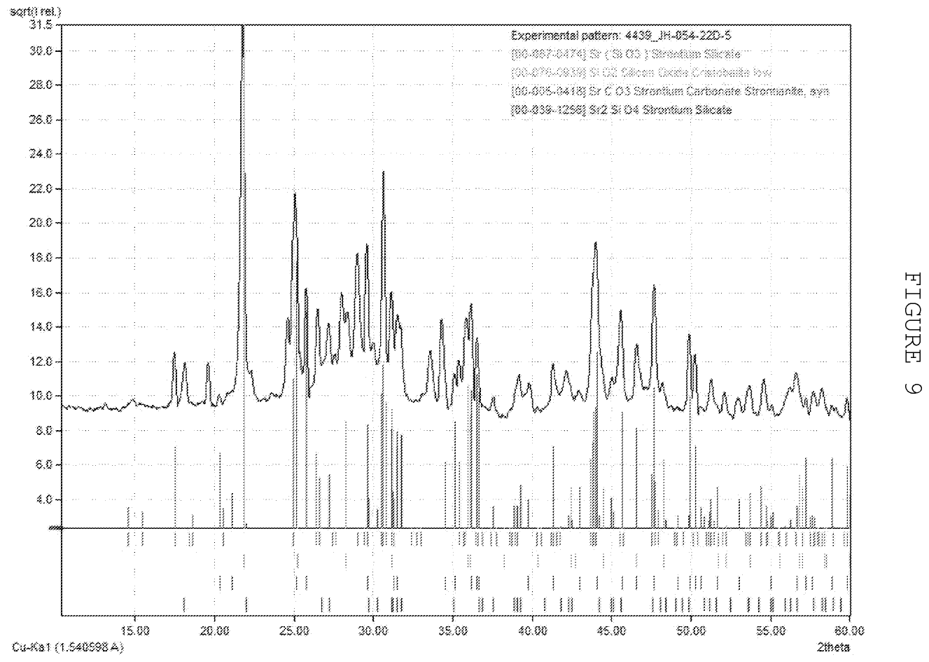

The XRD pattern of sintered pellet is shown in FIG. 9. The XRD pattern shows the formation of two Sr silicates, SrSiO₃ and Sr₂SiO₄, some cristobalite, unreacted SrCO₃, whereas the hump of the glass at about 25° 2θ does not appear clearly. The reaction, in this case, is not complete and there are unidentified diffraction lines that may belong to other strontium silicates. Thus, SrCO₃ also reacts with Pyrex-type glass at low temperatures, akin to BaCO₃, but at a slower rate.

### Example 87 (of the Invention)

### The Reaction of Ball Milled Pyrex-Type Glass Powder with BaCO₃

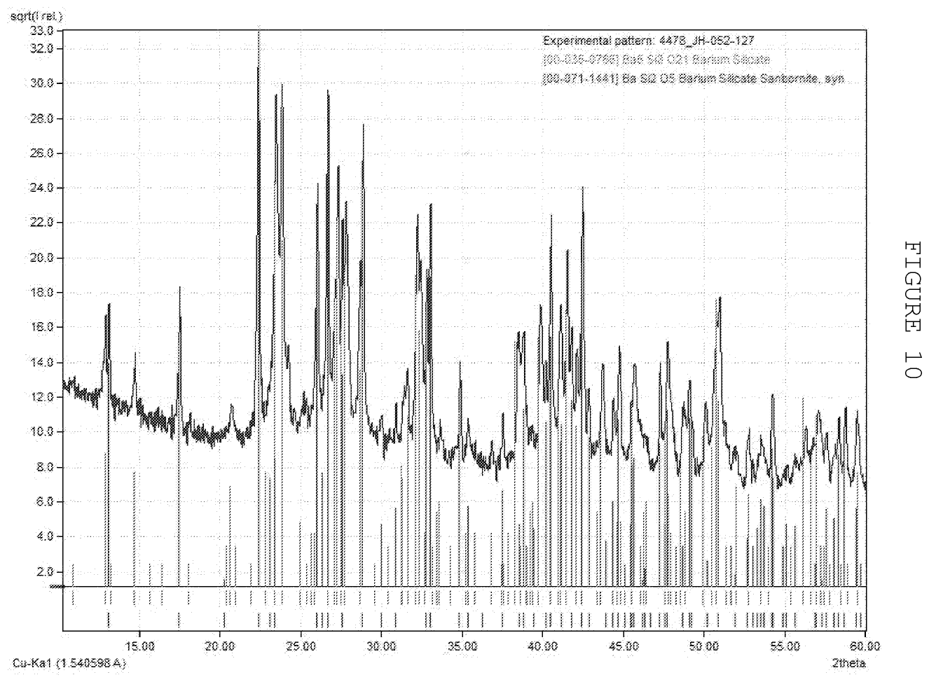

Ball milled Pyrex-type glass powder of preparation 3 (2.00 g) and BaCO₃ (3.202 g, 16.2258 mmol) were ground together with isopropanol in an agate mortar, dried, and heated in Pt crucible at 850° C. for 4 hours. The net weight of the reaction product after heating was 4.438 g (weight loss is 5.202 g-4.438 g=0.764 g). The theoretical weight loss for the complete reaction of BaCO₃ with glass is 0.714 g (16.2258 mmol of BaCO₃ release 0.714 g of CO₂) and it is very close to the experimental (0.764 g). Therefore, the reaction of BaCO₃ with the glass powder almost reached completion after four hours at 850° C. FIG. 10 presents the XRD of Example 87 (sample code JH-052-127) after the heat treatment. The XRD shows the formation of two barium silicates, BaSi₂O₅ as a major phase, Ba₅Si₈O₂₁ as a secondary phase as well as some cristobalite.

### Examples 88 (Invention) and 89 (Comparative)

### Comparison of Reactions of Vitreous and Crystalline Phase Silica with BaCO₃ at 850° C.

Commercial amorphous silica (2.00 g) and BaCO₃ (3.284 g, 16.643 mmol) were ground together with isopropanol in an agate mortar, dried, and heated in Pt crucible at 850° C. for 4 hours (Example 88, sample code JH-052-129A).

Commercial quartz (2.00 g) and BaCO₃ (3.284 g, 16.643 mmol) were ground together with isopropanol in an agate mortar, dried, and heated in Pt crucible at 850° C. for 4 hours together with Example 88 (Example 89, sample code JH-052-129B).

The theoretical weight loss in both examples for the complete reaction of BaCO₃ with glass is 0.732 g (16.643 mmol of BaCO₃ release 0.732 g of CO₂). The net weight of the reaction product after heating for Example 88 was 4.528 g (weight loss is 5.284 g-4.528 g=0.756 g), indicating the completion of the reaction. The net weight of the reaction product after heating for Example 89 was 5.118 g (weight loss is 5.284 g-5.118 g=0.166 g).

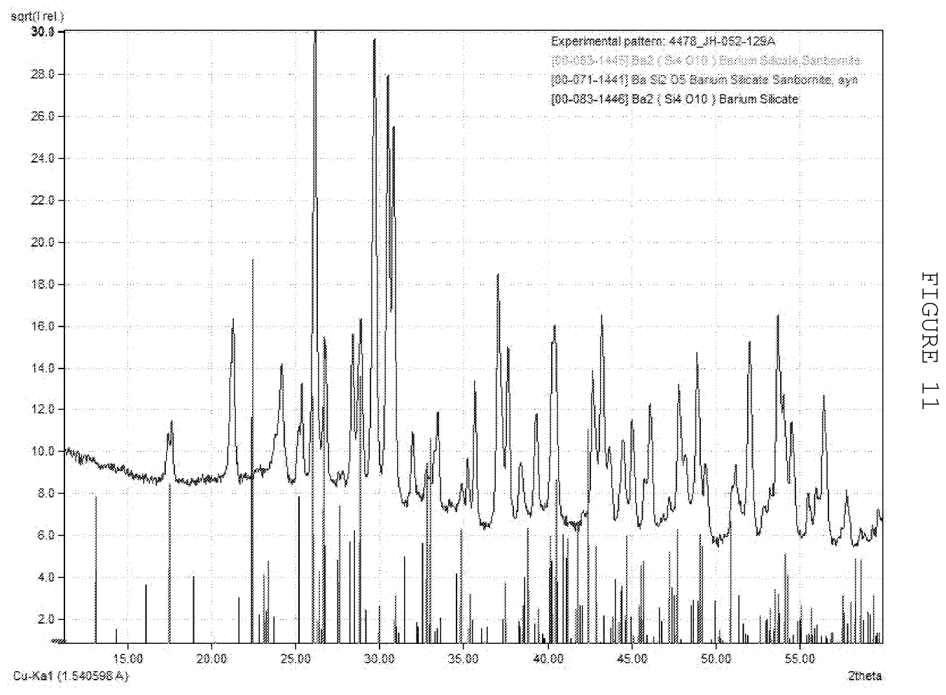

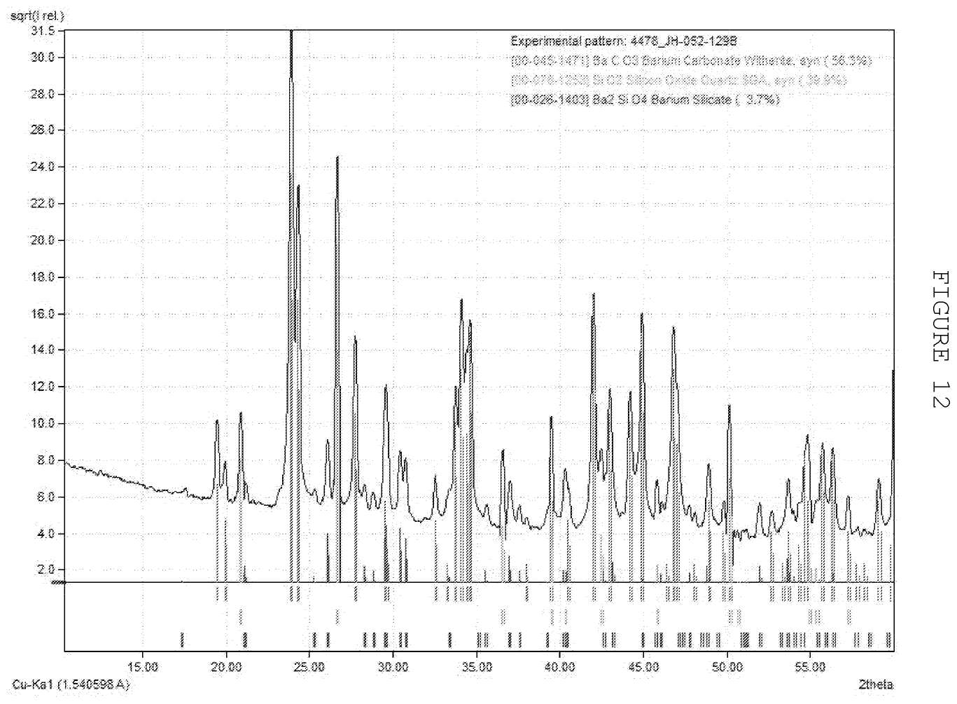

The results show that amorphous phase silica (Example 88, sample code JH-052-129A) reacted completely with BaCO₃ while crystalline phase silica (quartz, Example 89, JH-052-129B) reacts at a much slower rate. FIG. 11 shows the XRD pattern of Example 88 (sample code JH-052-129A), indicating that no BaCO₃ was left. FIG. 12 shows the XRD pattern of Example 89 (sample code JH-052-129B), indicating incomplete reaction with peaks of unreacted BaCO₃, quartz, and only a small quantity of Ba₂SiO₄ formed.

### Examples 90-95 (of the Invention)

The preparations of six silicates composites The preparations of six silicates composites are given in Table 8 (the same procedure of Example 87). The table details the ingredients and their weights in grams, the conditions of the heat treatment, and references to the corresponding XRD and major crystalline phases identified.

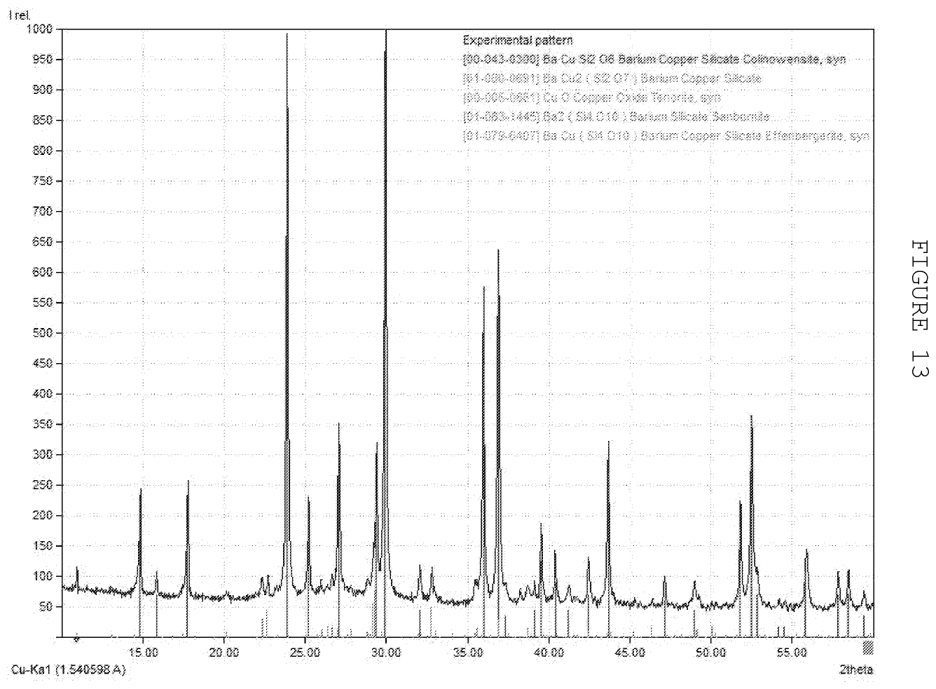

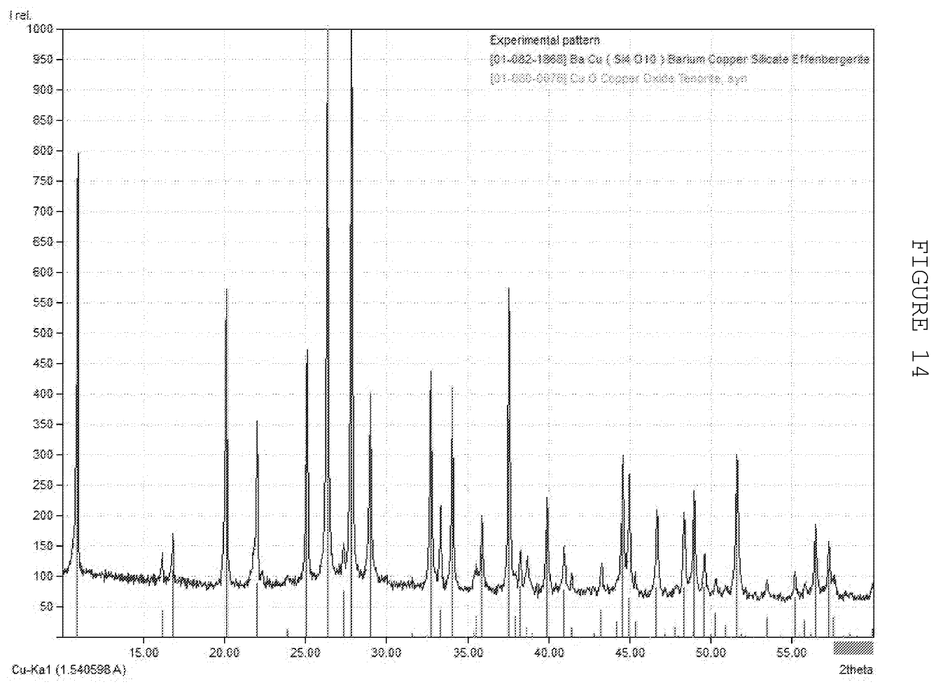

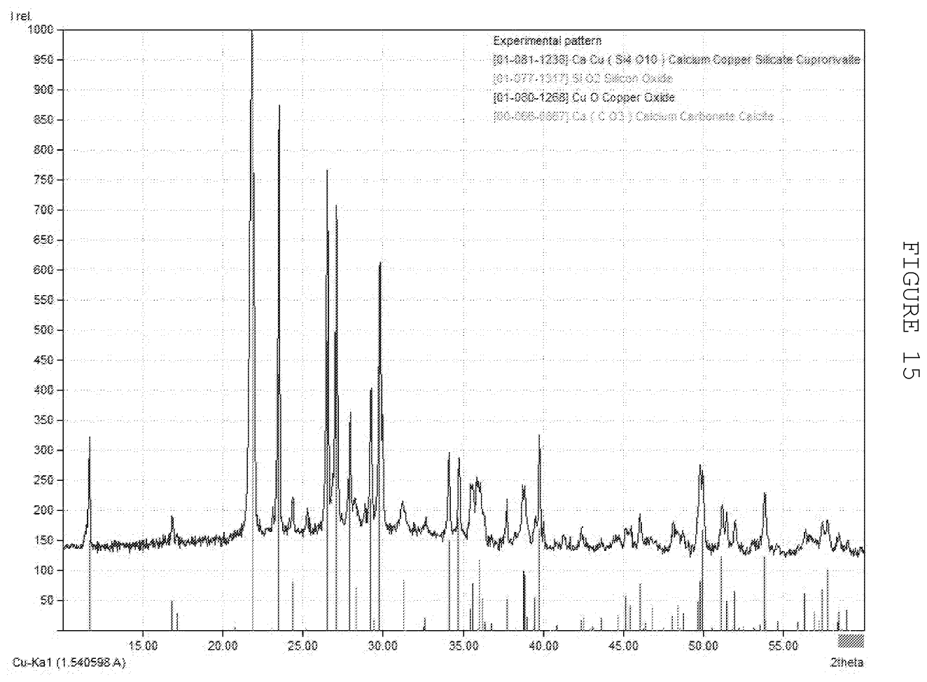

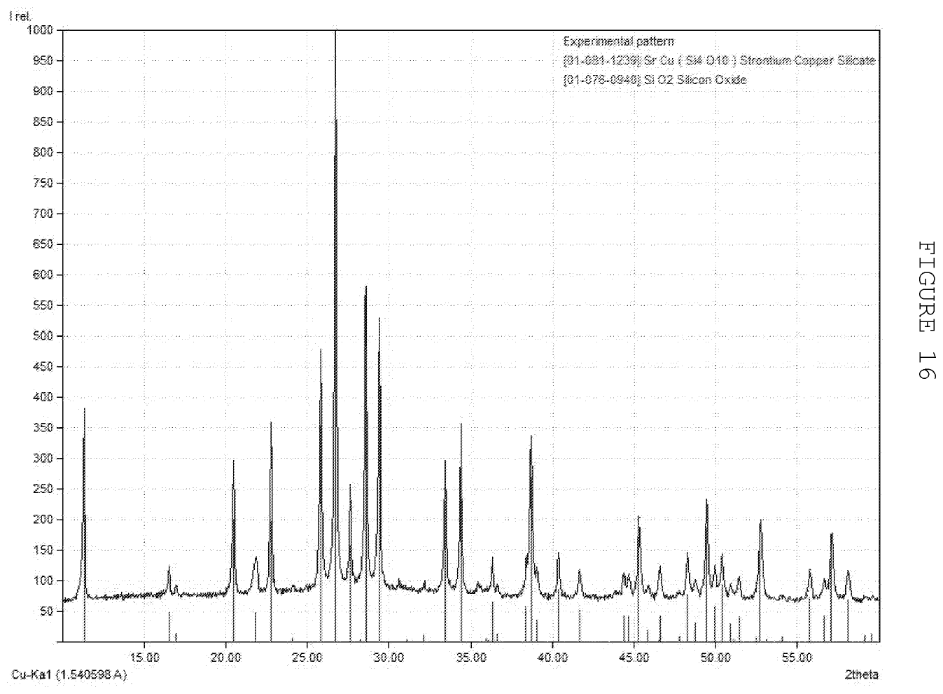

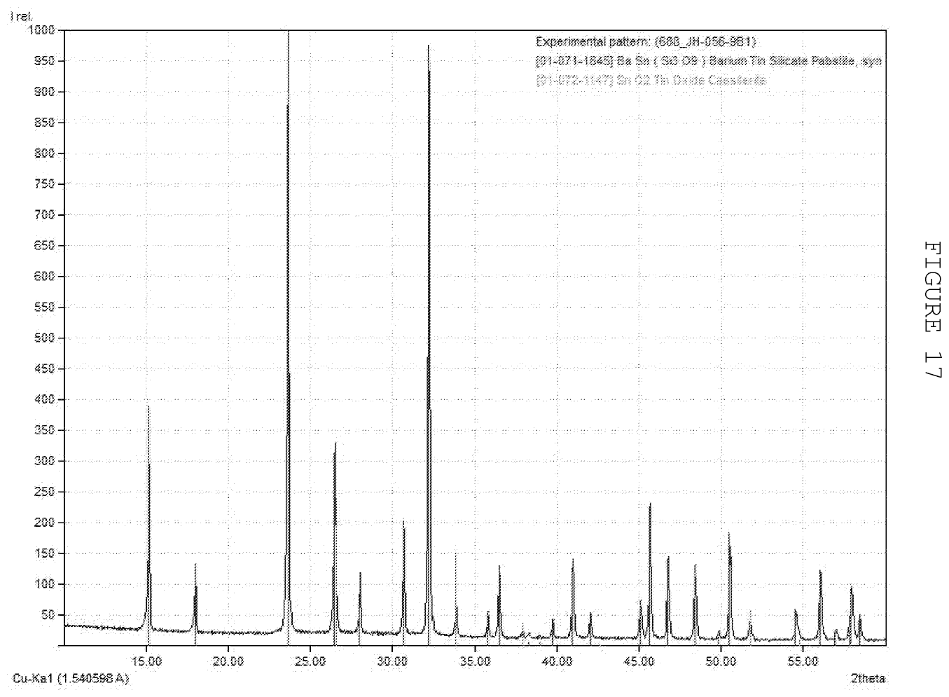

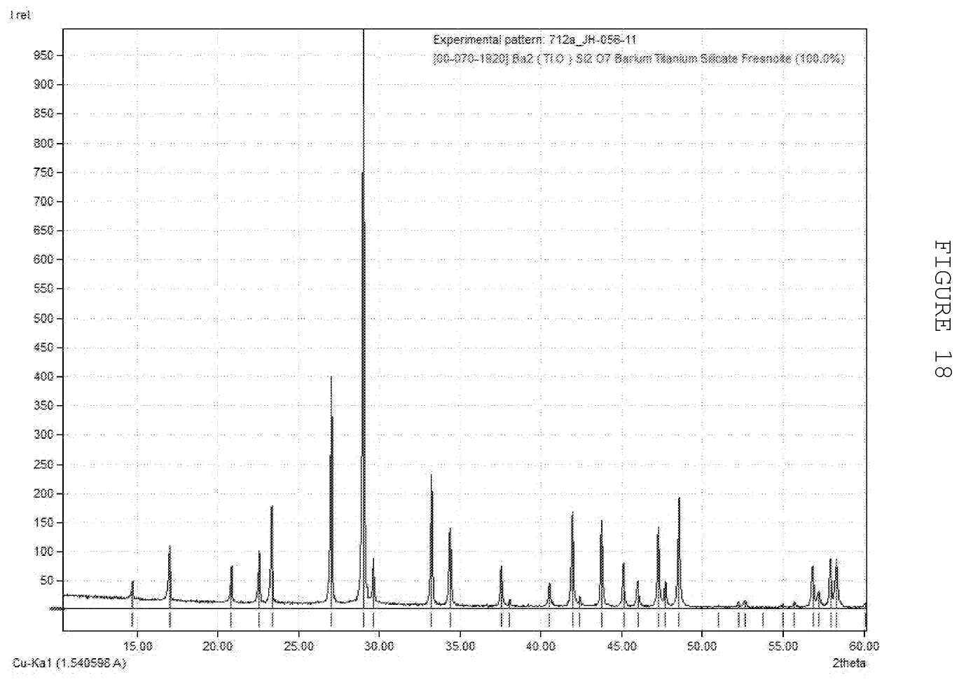

TABLE 8

| Example | Ingredients, g | | | | | | | Heat | |
|---|---|---|---|---|---|---|---|---|---|
| and code | Pyrex | BaCO₃ | CuO | TiO₂ | SnO₂ | CaCO₃ | SrCO₃ | treatment | XRPD |
| 90 JH-054-48 | 3.00 | 3.99 | 1.6084 | | | | | 900° C., 1 hr | FIG. 13 BaCuSi₂O₆ |
| 91 JH-054-49 | 6.00 | 3.99 | 1.6084 | | | | | 900° C., 1 hr | FIG. 14 BaCuSi₄O₁₀ |
| 92 JH-054-50 | 6.00 | | 1.6084 | | | 2.0219 | | 900° C., 1 hr | FIG. 15 CaCuSi₄O₁₀ |
| 93 JH-054-73 | 6.00 | | 1.6084 | | | | 2.9849 | 900° C., 1 hr | FIG. 16 SrCuSi₄O₁₀ |
| 94 JH-056-9B1 | 3.00 | 2.660 | | 0.2693 | 1.5236 | | | 950° C., 1 hr | FIG. 17 |
| | | | | | | | | 1100° C., 8 hr | BaTi_{0.25}Sn_{0.75}Si₃O₉ |
| 95 JH-056-11 | 3.00 | 7.981 | | 1.6157 | | | | 950° C., 1 hr | FIG. 18 Ba₂TiSi₂O₈ |

### Example 96

### Thermal Expansion of a Composite Made from Ball Milled Pyrex-Type Glass Powder and BaCO₃

Ball milled Pyrex-type glass powder of Preparation 3 (3.0 g, 81% SiO₂, 40.4 mmol of SiO₂) and BaCO₃ powder (3.99 g, 20.2 mmol of BaO, the molar ratio of BaO/SiO₂ is ½) were ground together with 45 drops of 3% PVA solution and shaped into a bar. The bar was dried on a hot plate to remove water, placed on Pt foil, and heated with 20° C./min gradient to 900° C. sintering temperature. After keeping the bar at 900° C. for 1 hour, it was cooled down to room temperature.

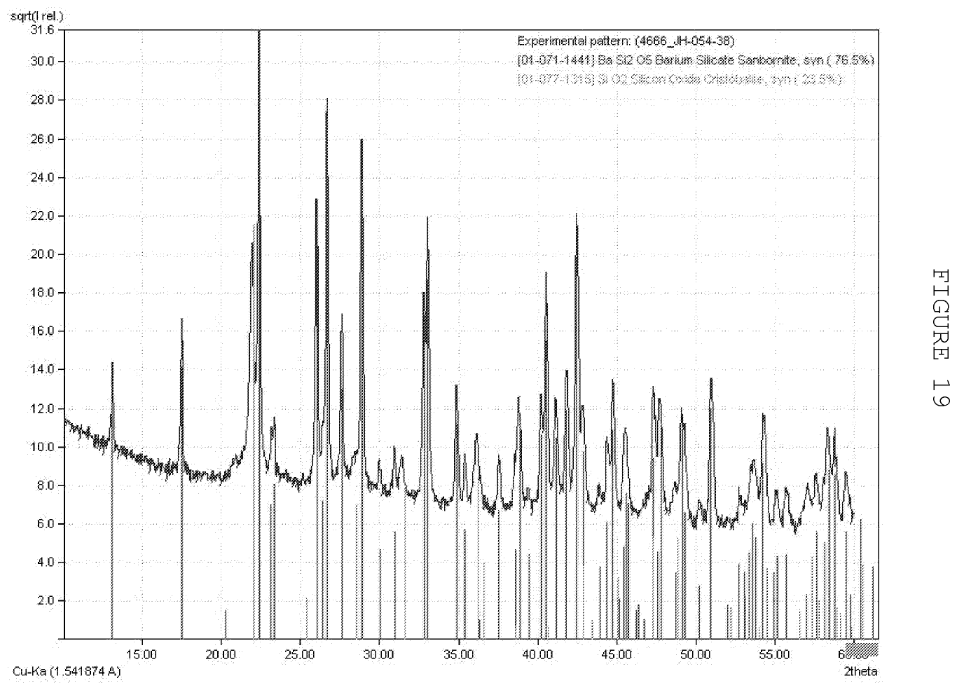

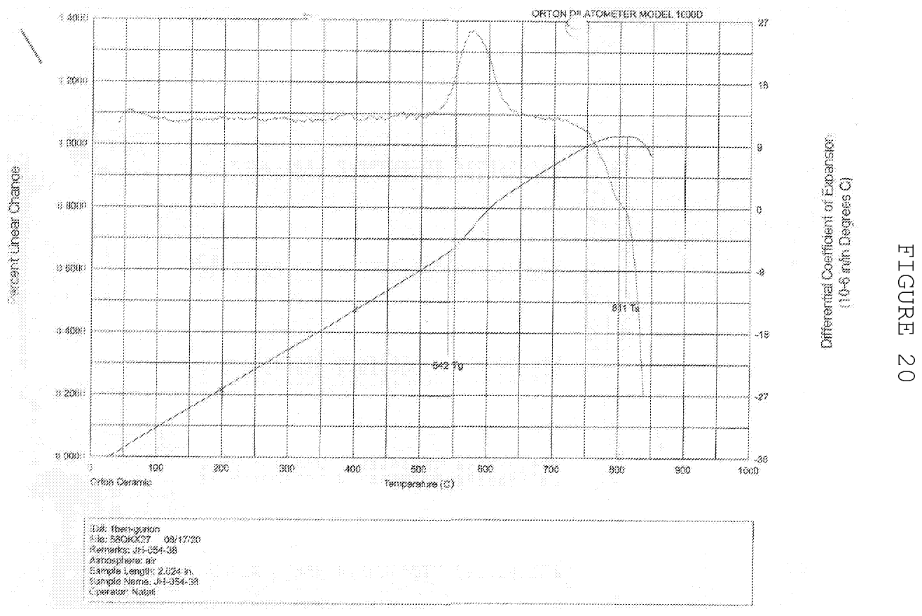

The XRD of the sintered bar (the sample code is JH-054-38) is presented in FIG. 19. It shows that the main phase formed is BaSi₂O₅ (Sanbornite). It is not clear about the presence of cristobalite, because all BaCO₃ reacted completely and there are no other phases of barium silicate in the XRD, and the dilatometer run is linear around 200° C. (FIG. 20). So, we conclude that after 1 hour at 900° C. the composite contains BaSi₂O₅ (Sanbornite) as a major phase and residual glass which contains the other ingredients of Pyrex (B₂O₃, Na₂O, K₂O, Al₂O₃ and traces of Fe₂O₃, MgO and CaO) and perhaps some dissolved BaSi₂O₅. If all SiO₂ in the Pyrex-type glass reacted with all BaCO₃ to form BaSi₂O₅, there are 5.53 g of BaSi₂O₅ and 0.57 g of residual glass. The wt. % of residual glass is estimated as 9.34.

The sintered bar was measured in a dilatometer. The dilatogram is presented in FIG. 20 (sample code JH-054-38). The data shows that the linear coefficient of expansion in the 200-400° C. range is 12.66 ppm/c.

FIG. 20 shows that percent linear change (PLC) is linear from room temperature to almost 500° C. (as also indicated by the constant value of the derivative of coefficient expansion (DCE). Linear PLC around 200° C. is an indication that cristobalite is not present in the glass composite. The average linear coefficient of expansion in the 100-400° C. range is 12.6×10⁻⁶C⁻¹. The dilatometer software selects the Tg (542° C.) and the dilatometer softening point Ts (821° C.) of the composite. These values, especially Ts, seem high for the residual glass (sodium aluminoborate glass); based on the published composition of Pyrex glass, the composition in wt. % of residual glass is 65.7 B₂O₃; 21.9 Na₂O; 11.5 Al₂O₃; 0.5 CaO; 0.26 MgO; 0.21 Fe₂O₃.

### Example 97 (Reference)

### Thermal Expansion of a Composite Made from Ball Milled Pyrex®-Type Glass Powder

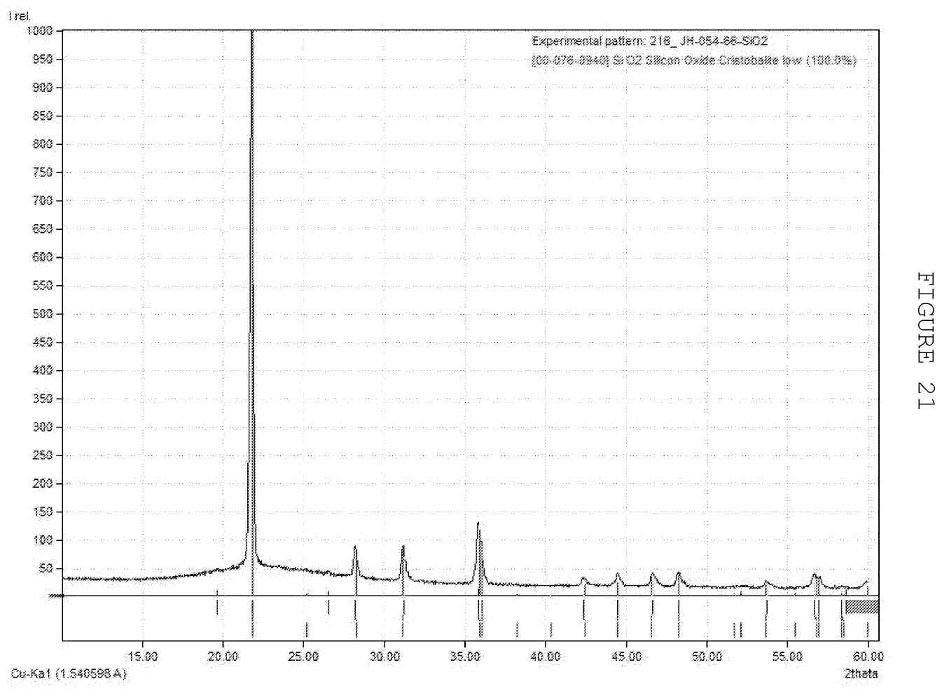

Ball milled Pyrex®-type glass powder from Preparation 3 without BaCO₃ was subjected to the same heat treatment used for Example 96, in order to account for the SiO₂ phase in FIG. 19. The XRD of the heat-treated Pyrex®-type powder (1 hour at 900° C.) is given in FIG. 21 (sample code JH-054-66) and it shows that Pyrex crystallizes after the heat treatment. It seems that the bar preparation procedure of Example 96 (sample code JH-054-38) did not form a homogeneous mixture, i.e., probably some large agglomerates of the Pyrex® glass still existed in the mixture and they crystallized during sintering.

### Example 98-100

### A Modified Procedure for Making a Composite Bar from Ball Milled Pyrex®-Type Glass Powder and BaCO₃

Ball milled Pyrex®-type glass powder from Preparation 3 (3.0 g) and BaCO₃ powder (3.99 g) were ground together with isopropanol in an agate mortar, dried, and then ground together with 45 drops of 3% PVA solution and shaped into a bar. The bar was dried on a hot plate to remove water and then sintered. The procedure includes the extra grinding step in agate mortar compared to Example 96.

Three bars with the same weight and materials used as in Example 96 were prepared using the modified procedure. The bars were placed on Pt foil and heated with a 20° C./min gradient to sintering temperature. After keeping the bar at the sintering temperature for 1 hour, it was cooled down to room temperature.

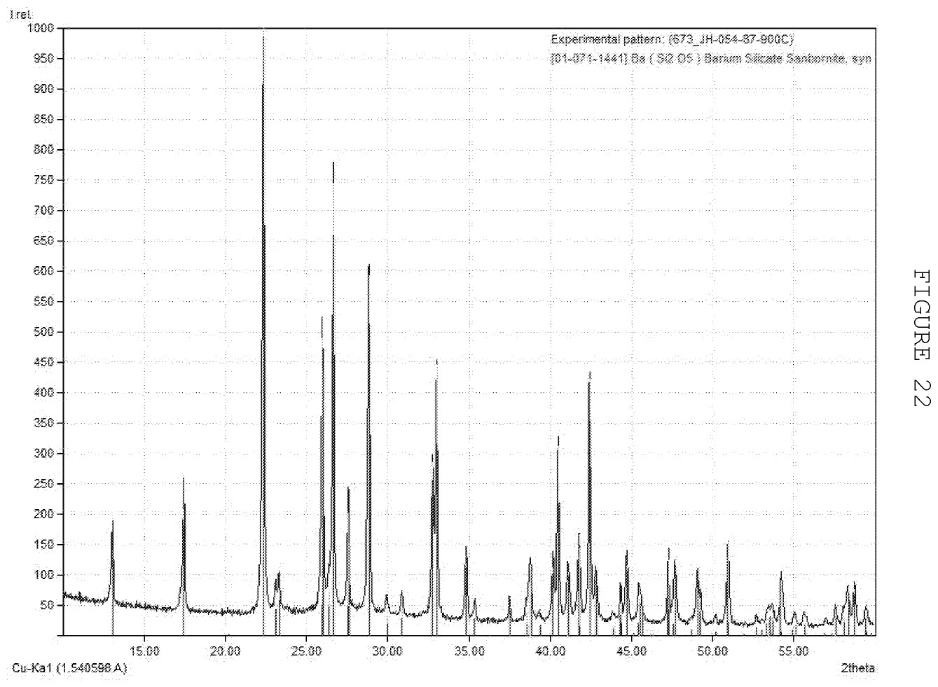

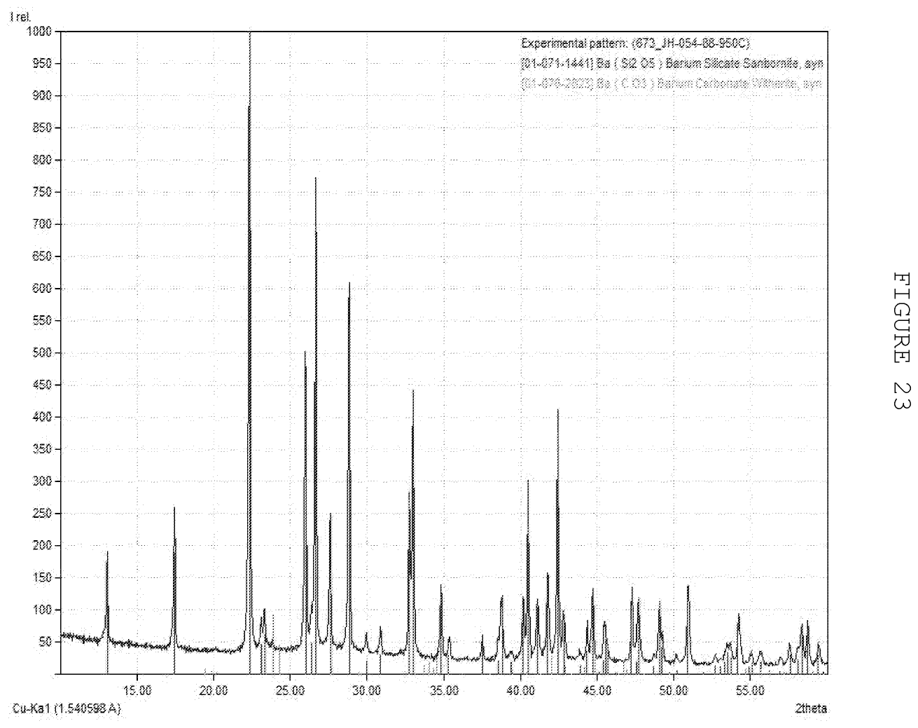

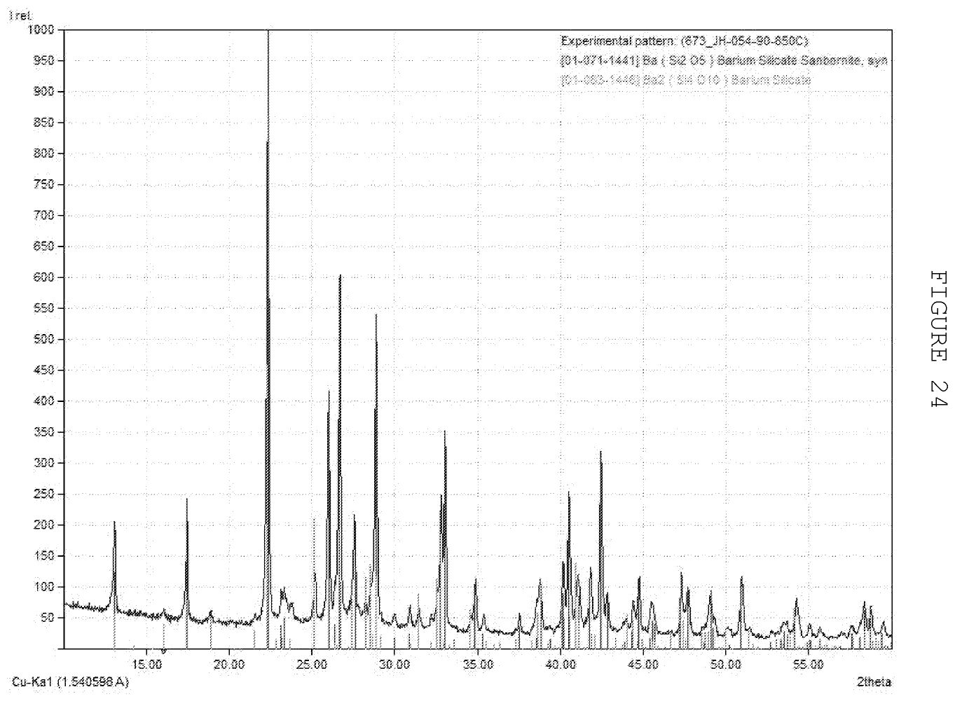

The bars were sintered for 1 hour at 900° C. (Example 98-sample code JH-054-87), 950° C. (Example 99-sample code JH-054-88), and 850° C. (Example 100-sample code JH-054-90). The bar from Example 99 (sample code JH-054-88) sintered at 950° C., broke before dilatometer measurements and the broken bar was used for XRD measurement. New bar identical to the bar from Example 99 was prepared (assigned new code JH-054-92). The XRD's of Example 98 (sample code JH-054-87), Example 99 (sample code JH-054-88), and Example 100 (sample code JH-054-90) are presented in FIGS. 22, 23 and 24.

The dilatometer measurements were performed three times for each of the bars. After the first run, the sample was left in the dilatometer and run again (to examples numbers and sample codes were added letter A), and after the second run, the sample was left in the dilatometer and run again for the third time (code changed from A to B).

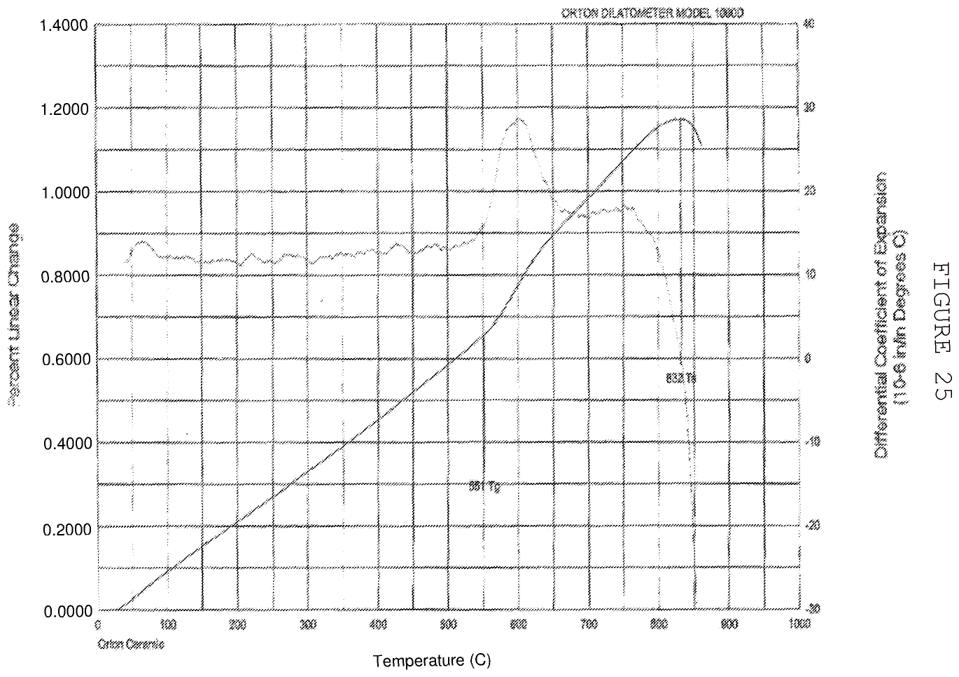

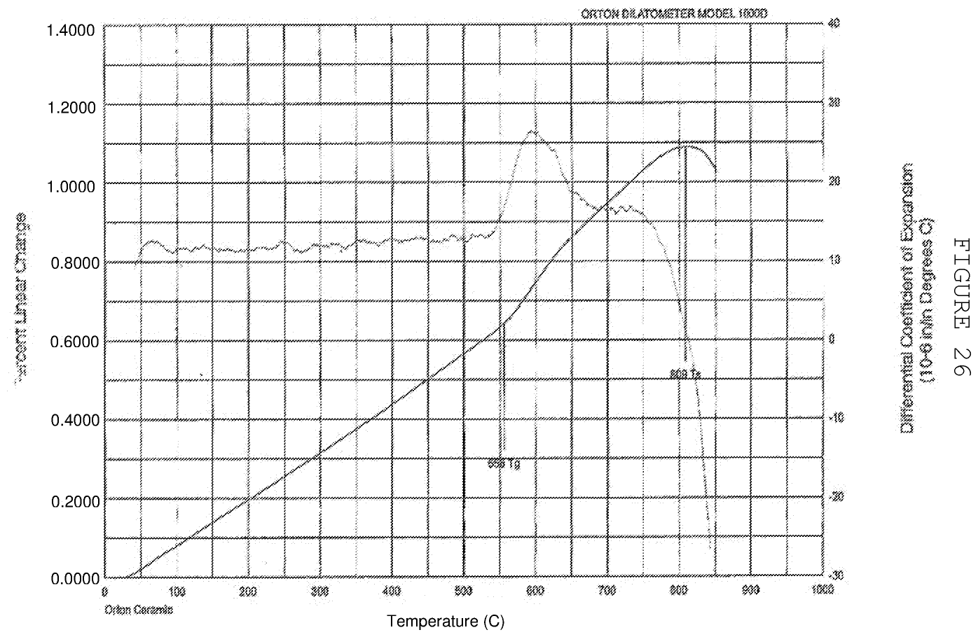

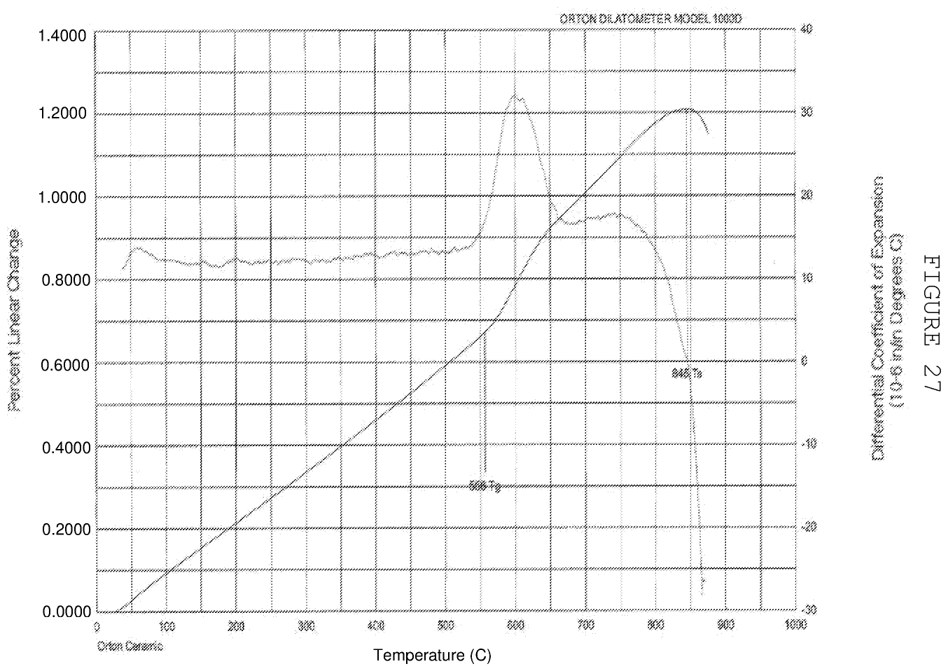

The dilatograms of 3^{rd} run for the Examples 98, 99 and 100 are presented on FIGS. 25, 26 and 27 respectively (Example 98B-JH-054-87B-900° C.; Example 99B-JH-054-90B-850° C.; and Example 100B-JH-054-92B-950° C.) and are identical to the dilatogram of the bar from Example 96 (sample code JH-054-38).

The dilatometer data of the samples are in Table 9 (three runs for each bar). There are presented also data for the first run of Example 96 (sample code JH-054-38). Run No. 1 was discarded (in the first run the bar may slightly move and can affect the measured TCE, in the second and third runs the bar is locked in the dilatometer and cannot shift), as only data for runs 2 and 3 were used to compare samples. The average TCE (200-400° C.) of Example 98 (sample code JH-054-87) (runs 2 and 3) is 12.3×10⁻⁶/° C., the corresponding values for Examples 99 (sample code JH-054-90) and Example 100 (sample code JH-054-92) are 11.95×10⁻⁶/° C. and 12.4×10⁻⁶/° C. respectively. The TCE of Example 98 (sample code JH-054-87, 900° C. sintering) and Example 100 (sample code JH-054-92, 950° C. sintering) are the same within experimental error. The corresponding TCE for Example 99 (sample code JH-04-90, 850° C. sintering) is slightly lower 11.95×10⁻⁶/° C.

TABLE 9

| Example and | CTE (200-400° C.) × | Heat | Run |
|---|---|---|---|
| code | 10\hat{ }6 | Treatment | number |
| 96 JH-054-38 | 12.7 | 900° C., 1 hour | 1 |
| 98 JH-054-87 | 10.6 | 900° C., 1 hour | 1 |
| 98A JH-054-87A | 12.4 | 900° C., 1 hour | 2 |
| 98B JH-054-87B | 12.2 | 900° C., 1 hour | 3 |
| 99 JH-054-90 | 10.8 | 850° C., 1 hour | 1 |
| 99A JH-054-90A | 11.8 | 850° C., 1 hour | 2 |
| 99B JH-054-90B | 12.1 | 850° C., 1 hour | 3 |
| 100 JH-054-92 | 12.7 | 950° C., 1 hour | 1 |
| 100A JH-054-92A | 12.4 | 950° C., 1 hour | 2 |
| 100B JH-054-92B | 12.4 | 950° C., 1 hour | 3 |

1. A process for preparing a porous glass, comprising mixing borosilicate glass powder with calcium carbonate particles to form a mixture, sintering the mixture at a temperature in the range from 750 to 850° C. to obtain a sintered body, cooling the sintered body and leaching calcium carbonate from the cooled sintered body with the aid of an acid.

2. A process for preparing a porous glass according to claim 1, further comprising processing the mixture into aa desired geometrical shape under the application of pressure and optionally in the presence of a binder, sintering at a temperature in the range from 750 to 850° C. to obtain a sintered body, wherein the cool down of the sintered body includes a step quenching of the sintered body at a temperature high enough to suppress calcium hydroxide formation; and leaching calcium carbonate from the quenched sintered body with the aid of a mineral acid.

3. A process according to claim 2, wherein the sintered body is quenched to a temperature in the range of 350° C. to 450° C.

4. A process for the preparation of one or more alkaline earth metal silicates by reacting a vitreous material and an alkaline earth carbonate, optionally in the presence of a transition metal or post-transition metal oxide, at aa temperature lower than 1200° C., to form a composite consisting of one or more alkaline earth metal silicates and aa residual glass, and optionally recovering the one or more silicates.

5. A process according to claim 4, wherein a vitreous material in a powder form, alkaline carbonate powder, and optionally one or more transition metal or post-transition metal oxide powders are mixed, and the mixture is subjected to at least one cycle of particle size reduction, to form a finely ground mixture.

6. A process according to claim 4, wherein the vitreous material is in the form of borosilicate glass powder.

7. A process according to claim 6, wherein the reaction occurs at a temperature in the range of 850° C. to 950° C.

8. A process according to claim 4, wherein the alkaline earth metal silicate has the formula MₐM_{b}^{I}M_{c}^{II}Si_{d}Oₑ in which:
M is an alkaline earth metal Ca, Sr or Ba, and a is 1 or 2;
M^{I} is a transition metal, and b is from 0 to 1, inclusive;
M^{II} is a post transition metal, and c is from 0 to 1, inclusive; such that the sum of b and c equals 0 or 1;
d is an integer in the range from 1 to 5, inclusive; and e is an integer in the range from 3 to 10, inclusive.

9. A process according to claim 8, wherein b and c both equal zero.

10. A process according to claim 9, comprising mixing borosilicate glass powder and barium carbonate powder to form a composite consisting of BaSi₂O₅ and residual glass.

11. A process according to claim 8, wherein M^{I} is Cu or Ti, M^{II} is Sn, 0.1<b≤1 and 0≤c<0.9.

12. A process according to claim 11, comprising mixing borosilicate powder, alkaline earth carbonate powder and one or more powders selected from CuO, TiO₂ and SnO₂, wherein the composite prepared comprises an alkaline earth metal silicate selected from the group consisting of: BaCuSi₂O₆, BaCuSi₄O₁₀.
